(19) United States
(12) Patent Application Publication
(10) Pub. No.: US 2008/0123507 A1
(43) Pub. Date: May 29, 2008

(54) OPTICAL ELEMENT AND OPTICAL PICKUP APPARATUS

(76) Inventors: Kunihiko TAKA, Tokyo (JP); Setsuo Tokuhiro, Tokorozawa-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/944,919

(22) Filed: Nov. 26, 2007

(30) Foreign Application Priority Data
Nov. 29, 2006 (JP) JP2006-321255

(51) Int. Cl. G11B 7/135

(52) U.S. Cl. 369/112.05

(57) ABSTRACT

The present invention provides an optical element for use in an optical pickup apparatus which records and/or reproduces information, and for converging a laser light flux with a wavelength λ1 on an information recording medium. The optical element includes; a main body; and an antireflection film arranged on at least one surface of the main body and including an optical functional surface. In the optical element, a maximum angle θ1 formed by a normal of the optical functional surface and the laser light flux satisfies 40°≦θ1≦70°, and a phase difference between a phase of a P-polarized light and a phase of a S-polarized light of the laser light flux when the laser light flux enters into the optical element, is the substantially same to the phase difference when the laser light flux is emitted from the optical element.

This application is based on Japanese Patent Application No. 2006-321255 filed on Nov. 29, 2006, in Japanese Patent Office, the entire content of which is hereby incorporated by reference.

### TECHNICAL FIELD

The present invention relates to an optical element including an antireflection film and to an optical pickup apparatus including the optical element.

### BACKGROUND

In the past, as the density of the optical pickup apparatus has become higher, the wavelength of the laser light used is being shortened and the numerical aperture of the optical elements such as an objective lens has been increasing. For example, in the optical pickup apparatus using laser light of a wavelength of 405 nm, the numerical aperture has generally become as large as in the range of 0.6 to 0.9 and the maximum angle of incidence of laser light for the objective lens has become in the range of 60° to 70°.

It is to be noted that, in order to perform accurate recording and reproduction of information, the beam spot must maintain a favorable shape. In an objective lens, the outer periphery portion has a large incident angle and high reflectance and the center portion has low reflectance. In order for the beam spot to maintain a favorable shape, it is necessary to keep the transmittances at both of the outer periphery portion and the center portion equal as they remain high. For this reason, in objective lens of recent years, an antireflection film that has a multi-layer construction has been provided (For example, refer to Japanese unexamined Patent Application Publication No. 10-160906).

However, even when an antireflection film with a multilayer construction is simply provided on an objective lens, the condition that the polarized laser light enters into the objective lens makes a change in the phase difference between the P-polarized light phase and the S-polarized light phase at the peripheral portion where the incident angle is larger between when the incident laser light enters into the antireflection film and when the incident laser light is emitted from the antireflection film. It results in failure of obtaining the ideal polarized light form and the beam spot still has a deteriorated shape. In addition, the change in the phase difference occurs cross talk that occurs when light reflected from the optical disk (return light) returns to the laser and weakening of the optical disk signal. In particular, cross talk has an adverse effect on laser oscillation and this leads to unstable oscillation of laser beams such as wavelength drift or noise. On the other hand, the transmittance of the laser beam in the objective lens becomes low under the condition that an antireflection film is not provided.

### SUMMARY

An object of the present invention is to provide an optical element that is capable of: maintaining high transmittance while keeping a favorable beam shape; reducing or preventing cross talk which is caused by return light from the optical disk; and reducing or preventing weakening of the signals, and to provide an optical pickup apparatus which includes this optical element.

An optical element according to the present invention is an optical element for use in an optical pickup apparatus which records and/or reproduces information, and for converging a laser light flux with a wavelength λ1 on an information recording medium. The optical element includes: a main body; and an antireflection film arranged on at least one surface of the main body and including an optical functional surface. In the optical element, a maximum angle θ1 formed by a normal of the optical functional surface and the laser light flux satisfies 40°≦θ1≦70°, and a phase difference between a phase Pp1 of a P-polarized light and a phase Ps1 of a S-polarized light of the laser light flux when the laser light flux enters into the optical element, is the substantially same to the phase difference when the laser light flux is emitted from the optical element.

These and other objects, features and advantages according to the present invention will become more apparent upon reading of the following detailed description along with the accompanied drawings.

### BRIEF DESCRIPTION OF THE DRAWINGS

Embodiments will now be described, by way of example only, with reference to the accompanying drawings which are meant to be exemplary, not limiting, and wherein like elements numbered alike in several Figures, in which:

FIG. 1 is a schematic view showing the schematic structure of an optical pickup apparatus relating to the present invention;

FIG. 2 is a schematic view for explaining the operation of an optical pickup apparatus relating to the present invention;

FIG. 3 is a schematic view for illustrating the maximum angle formed by the laser light flux and the optical functional surface;

FIG. 4 is a side view showing the objective lens relating to the present invention;

each of FIGS. 5(a) and 5(b) shows the evaluation results of Example 1, FIG. 5(a) shows the reflectance characteristics, and FIG. 5(b) shows the change amount in the phase difference from when a laser light flux having a wavelength of λ1 enters into the antireflection tilts to when the laser light flux is emitted from the antireflection film;

each of FIGS. 6(a) and 6(a) shows the evaluation results of Example 2, FIG. 6(a) shows the reflectance characteristics, and FIG. 6(b) shows the change amount in the phase difference from when a laser light flux having a wavelength of λ1 enters into the antireflection film to when the laser light flux is emitted from the antireflection film;

each of FIGS. 7(a) and 7(b) shows the evaluation results of Example 3, FIG. 7(a) shows the reflectance characteristics, and FIG. 7(b) shows the change amount in the phase difference from when a laser light flux having a wavelength of λ1 enters into the antireflection film to when the laser light flux is emitted from the antireflection film;

each of FIGS. 8(a) and 8(b) shows the evaluation results of Example 4, FIG. 8(a) shows the reflectance characteristics, and FIG. 8(b) shows the change amount in the phase difference from when a laser light flux having a wavelength of λ1 enters into the antireflection film to when the laser light flux is emitted from the antireflection film;

each of FIGS. 9(a) and 9(b) shows the evaluation results of Example 5, FIG. 9(a) shows the reflectance characteristics, and FIG. 9(b) shows the change amount in the phase difference from when a laser light flux having a wavelength of λ1 enters into the antireflection film to when the laser light flux is emitted from the antireflection film;

each of FIGS. 10(a) and 10(b) shows the evaluation results of Example 6, FIG. 10(a) shows the reflectance characteristics, and FIG. 10(b) shows the change amount in the phase difference from when a laser light flux having a wavelength of λ1 enters into the antireflection film to when the laser light flux is emitted from the antireflection film;

each of FIGS. 11(a) and 11(b) shows the evaluation results of Example 7, FIG. 11(a) shows the reflectance characteristics, and FIG. 11(b) shows the change amount in the phase difference from when a laser light flux having a wavelength of λ1 enters into the antireflection film to when the laser light flux is emitted from the antireflection film;

each of FIGS. 12(a) and 12(b) shows the evaluation results of Example 8, FIG. 12(a) shows the reflectance characteristics, and FIG. 12(b) shows the change amount in the phase difference from when a laser light flux having a wavelength of λ1 enters into the antireflection film to when the laser light flux is emitted from the antireflection film;

each of FIGS. 13(a) and 13(b) shows the evaluation results of Example 9, FIG. 13(a) shows the reflectance characteristics, and FIG. 13(b) shows the change amount in the phase difference from when a laser light flux having a wavelength of λ1 enters into the antireflection film to when the laser light flux is emitted from the antireflection film;

each of FIGS. 14(a) and 14(b) shows the evaluation results of Example 10, FIG. 14(a) shows the reflectance characteristics, and FIG. 14(b) shows the change amount in the phase difference from when a laser light flux having a wavelength of λ1 enters into the antireflection film to when the laser light flux is emitted from the antireflection film;

each of FIGS. 15(a) and 15(b) shows the evaluation results of Example 11, FIG. 15(a) shows the reflectance characteristics, and FIG. 15(b) shows the change amount in the phase difference from when a laser light flux having a wavelength of λ1 enters into the antireflection film to when the laser light flux is emitted from the antireflection film;

each of FIGS. 16(a) and 16(b) shows the evaluation results of Example 12, FIG. 16(a) shows the reflectance characteristics, and FIG. 16(b) shows the change amount in the phase difference from when a laser light flux having a wavelength of λ1 enters into the antireflection film to when the laser light flux is emitted from the antireflection film;

each of FIGS. 17(a) and 17(b) shows the evaluation results of Example 13, FIG. 17(a) shows the reflectance characteristics, and FIG. 17(b) shows the change amount in the phase difference from when a laser light flux having a wavelength of λ1 enters into the antireflection film to when the laser light flux is emitted from the antireflection film;

each of FIGS. 18(a) and 18(b) shows the evaluation results of Example 14, FIG. 18(a) shows the reflectance characteristics, and FIG. 18(b) shows the change amount in the phase difference from when a laser light flux having a wavelength of λ1 enters into the antireflection film to when the laser light flux is emitted from the antireflection film.

each of FIGS. 19(a) and 19(b) shows the evaluation results of Example 15, FIG. 19(a) shows the reflectance characteristics, and FIG. 19(b) shows the change amount in the phase difference from when a laser light flux having a wavelength of λ1 enters into the antireflection film to when the laser light flux is emitted from the antireflection film;

each of FIGS. 20(a) and 20(b) shows the evaluation results of Example 16, FIG. 20(a) shows the reflectance characteristics, and FIG. 20(b) shows the change amount in the phase difference from when a laser light flux having a wavelength of λ1 enters into the antireflection film to when the laser light flux is emitted from the antireflection film;

each of FIGS. 21(a) to 21(d) shows the evaluation results of Example 17, FIG. 21(a) shows the reflectance characteristics, and each of FIGS. 21(b) to 21(d) shows the change amount in the phase difference from when a laser light flux having each of wavelengths of λ1 to λ3 enters into the antireflection film to when the laser light flux is emitted from the antireflection film;

each of FIGS. 22(a) to 22(d) shows the evaluation results of Example 18, FIG. 22(a) shows the reflectance characteristics, and each of FIGS. 22(b) to 22(d) shows the change amount in the phase difference from when a laser light flux having each of wavelengths of λ1 to λ3 enters into the antireflection film to when the laser light flux is emitted from the antireflection film;

each of FIGS. 23(a) to 23(d) shows the evaluation results of Example 19, FIG. 23(a) shows the reflectance characteristics, and FIGS. 23(b) to 23(d) shows the change amount in the phase difference from when a laser light flux having each of wavelengths of λ1 to λ3 enters into the antireflection film to when the laser light flux is emitted from the antireflection film;

each of FIGS. 24(a) to 24(d) shows the evaluation results of Example 20, FIG. 24(a) shows the reflectance characteristics, and each of FIGS. 24(b) to 24(d) shows the change amount in the phase difference from when a laser light flux having each of wavelengths of λ1 to λ1 enters into the antireflection film to when the laser light flux is emitted from the antireflection film;

each of FIGS. 25(a) to 25(d) shows the evaluation results of Example 21, FIG. 25(a) shows the reflectance characteristics, and each of FIGS. 25(b) to 25(d) shows the change amount in the phase difference from when a laser light flux having each of wavelengths of λ1 to λ3 enters into the antireflection film to when the laser light flux is emitted from the antireflection film;

each of FIGS. 26(a) to 26(d) shows the evaluation results of Example 22, FIG. 26(a) shows the reflectance characteristics, and each of FIGS. 26(b) to 26(d) shows the change amount in the phase difference from when a laser light flux having each of wavelengths of λ1 to λ3 enters into the antireflection film to when the laser light flux is emitted from the antireflection film; and

each of FIGS. 27(a) to 27(d) shows the evaluation results of the Comparative Example, FIG. 27(a) shows the reflectance characteristics, and each of FIGS. 27(b) to 27(d) shows the change amount in the phase difference from when a laser light flux having each of wavelengths of λ1 to λ3 enters into the antireflection film to when the laser light flux is emitted from the antireflection film.

### DESCRIPTION OF THE PREFERRED EMBODIMENT

The following is a description of preferred embodiments of the present invention.

An embodiment of the present invention is an optical element for use in an optical pickup apparatus which records and/or reproduces information and for converging a first laser light flux with a wavelength λ1 on an information recording medium. The optical element comprises: a main body; and an antireflection film arranged on at least one surface of the main body and comprising an optical functional surface. In the optical element, a maximum angle θ1 formed by a normal of the optical functional surface and the first laser light flux satisfies 40°≦θ1≧70°, and the optical element satisfies |Δ4|≦6°, where Δ4 is a change amount in a phase difference between a phase Pp1 of a P-polarized light and a phase Ps1 of a S-polarized light of the first laser light flux, from when the first laser light flux enters into the optical element, to when the first laser light flux is emitted from the optical element.

In the above optical element, the antireflection film preferably satisfies |Δ1|≦6°, where Δ1 is a change amount in the phase difference between a phase Pp1 of a P-polarized light and a phase Ps1 of a S-polarized light of the first laser light flux, from when the first laser light flux enters into the antireflection film, to when the first laser light flux is emitted from the antireflection film.

In the above optical element, the wavelength λ1 preferably satisfies 390 nm≦λ1≦430 nm.

In the above optical element, it is preferable that the optical element further converges a second laser light flux with a wavelength λ2 (630 nm≦λ2≦670 nm) and a third laser light flux with a wavelength λ3 (760 nm≦λ3≦820 nm) on respective information receding media, and the wavelength λ1 satisfies 390 nm≦λ1≦430 nm.

In the above optical element, it is preferable that a maximum angle θ2 formed by a normal of the optical functional surface and the second laser light flux satisfies 40°≦θ2≦60°, and the optical element satisfies |Δ5|≦6°, where Δ5 is a change amount in a phase difference between a phase Pp2 of a P-polarized light and a phase Ps2 of a S-polarized light of the second laser light flux, from when the second laser light flux enters into the optical element, to when the second laser light flux is emitted from the optical element. Further, it is preferable that a maximum angle θ3 formed by a normal of the optical functional surface and the third laser light flux satisfies 40°≦θ3≦50°, and the optical element satisfies |Δ6|≦6°, where Δ6 is a change amount in a phase difference between a phase Pp3 of a P-polarized light and a phase Ps3 of a S-polarized light of the third laser light flux, from when the third laser light flux enters into the optical element, and to when the third laser light flux is emitted from the optical element.

In the above optical element, it is preferable that the antireflection film satisfies |Δ2|≦6°, where Δ2 is a change amount in the phase difference between a phase Pp2 of a P-polarized light and a phase Ps2 of a S-polarized light of the second laser light flux from when the second laser light flux enters into the antireflection film, to when the second laser light flux is emitted from the antireflection film. Further, it is preferable that the optical antireflection film |Δ3|≦6°, where Δ3 is a change amount in the phase difference between a phase Pp3 of a P-polarized light and a phase Ps3 of a S-polarized light of the third laser light flux, from when the third laser light flux enters into the antireflection film, to when the third laser light flux is emitted from the antireflection film.

In the optical element, the change amount Δ4 preferably satisfies |Δ4|≦4°.

In the optical element, the change amount Δ4 more preferably satisfies |Δ4|≦1°.

In the optical element, the change amount Δ1 preferably satisfies |Δ1|≦4°.

In the optical element, the change amount Δ1 more preferably satisfies |Δ1|≦1°.

In the optical element, each of opposite surfaces of the optical element preferably comprises the antireflection film.

In the optical element, the antireflection film preferably comprises: a lower refractive index material satisfying 1.3≦n<1.55; and a higher refractive index material satisfying 1.8≦n<2.5, where n is a refractive index of each of the lower refractive index material and the higher refractive index material for a light flux with a wavelength of 500 nm.

In the optical element, the antireflection film is preferably formed of a plurality of layers whose numbers are from 5 to 11, and the antireflection film preferably satisfies 0.4≦δ≦0.55, where δ is a refractive-index difference of neighboring layers among the plurality of layers.

In the optical element, it is preferable that the lower refractive index material comprises MgF₂ or SiO₂ as a main component, and the higher refractive index material comprises TiO₂, Ta₂O₅, CeO₂, ZrO₂, HfO₂, La₂O₃, Nb₂O₅, or TiLaOx as a main component.

In the optical element, it is more preferable that the lower refractive index material comprises MgF₂ or SiO₂ as a main component, and the higher refractive index material comprises TiO₂, Ta₂O₅, CeO₂, ZrO₂, or HfO₂ as a main component.

In the optical element, it is preferable that the lower refractive index material comprises SiO₂ as a main component, and the higher refractive index material comprises ZrO₂ or HfO₂ a main component.

In the optical element, the antireflection film preferably comprises: a lower refractive index material satisfying 1.3≦n<1.55; a middle refractive index material satisfying 1.55≦n<1.8; and a higher refractive index material satisfying 1.8≦n<2.5, where n is a refractive index of the lower refractive index material, the middle refractive index material, and the higher refractive index material for a light flux with a wavelength of 500 nm.

In the optical element, it is preferable that the lower refractive index material comprises MgF₂ or SiO₂ as a main component, the middle refractive index material comprises Al₂O₃ as a main component, and the higher refractive index material comprises TiO₂, Ta₂O₅, CeO₂, ZrO₂, HfO₂, La₂O₃, Nb₂O₅, or TiLaOx as a main component.

Further, it is more preferable that the lower refractive index material comprises MgF₂ or SiO₂ as a main component, the middle refractive index material comprises Al₂O₃ as a main component, and the higher refractive index material comprises TiO₂, Ta₂O₅, CeO₂, ZrO₂, or HfO₂ as a main component.

In the optical element, the optical element is preferably formed by a plastic molding.

Another embodiment of the present invention is an optical pickup apparatus comprising: a laser light source for emitting a laser light flux with a wavelength λ1; and any one of the above optical elements. In the optical pickup apparatus, the optical element converges the laser light flux on an information recording medium so that the maximum angle θ1 satisfies 40°≦θ1≦70°, and the optical pickup apparatus conducts at least one of: recording information to the information recording medium; and reproducing information recorded on the information recording medium.

According to the embodiments of the present invention, high transmittance can be maintained while keeping a favorable beam spot shape, and cross talk which is caused by return light from the optical disk can be reduced or prevented and also weakening of the signals can be reduced or prevented.

The following is a description of an embodiment of the present invention in detail with reference to the drawings.

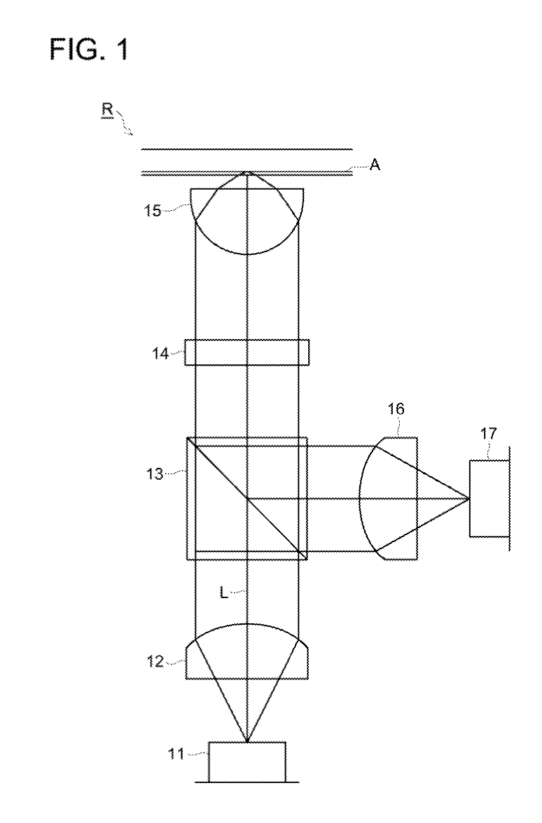

FIG. 1 is a schematic view showing the schematic structure of an optical pickup apparatus 1 relating to the present invention.

As shown in FIG. 1, the optical pickup apparatus 1 records information on an information recording surface A of an information recording medium R and reads or reproduces information that has been recorded on the information recording surface A, and it comprises a laser diode 11. As the information recording medium R, BD (Blu-Ray disc) or HD-DVD cab be used, and the information recording medium R in this embodiment is a BD. In addition, the thickness of the protective layer of the information recording medium R is 0.1 mm.

The laser diode 11 represents a laser light source in the present embodiment. When the information recording medium R is utilized as the information recording medium and information is recorded and/or reproduced on the information recording medium R, the laser diode 11 emits a laser light flux having a wavelength of λ1 (390 nm≦λ1≦430 nm). The wavelength λ1 is 405 nm in this embodiment.

In the optical pickup apparatus, there are arranged a collimator lens 12, a polarized beam splitter 13, a ¼ wavelength plate 14 and an objective lens 15 in that order in the direction of the optical axis L of the laser light flux emitted from the laser diode 11, from the bottom to the top of the sheet of FIG. 1. Around the objective lens 15, there is arranged an actuator (not shown) that moves the objective lens in the vertical direction in FIG. 1. The information recording medium R is arranged at a position opposing the objective lens 15.

In addition, a convex lens 16 and an optical detector 17 are arranged in that order at the left side of the polarized beam splitter 13 in FIG. 1.

Next, the operation and effects of the optical pickup apparatus 1 will be described briefly.

When information is recorded on the information recording medium R or when information on the information recording medium R is reproduced, the laser diode 11 emits a laser light flux having a wavelength λ1. This laser light flux is first converted to parallel light by the collimator lens 12 and then only P-polarized component of the light is transmitted by the polarized beam splitter 13 and then converted to straight-polarized light (P-polarized light).

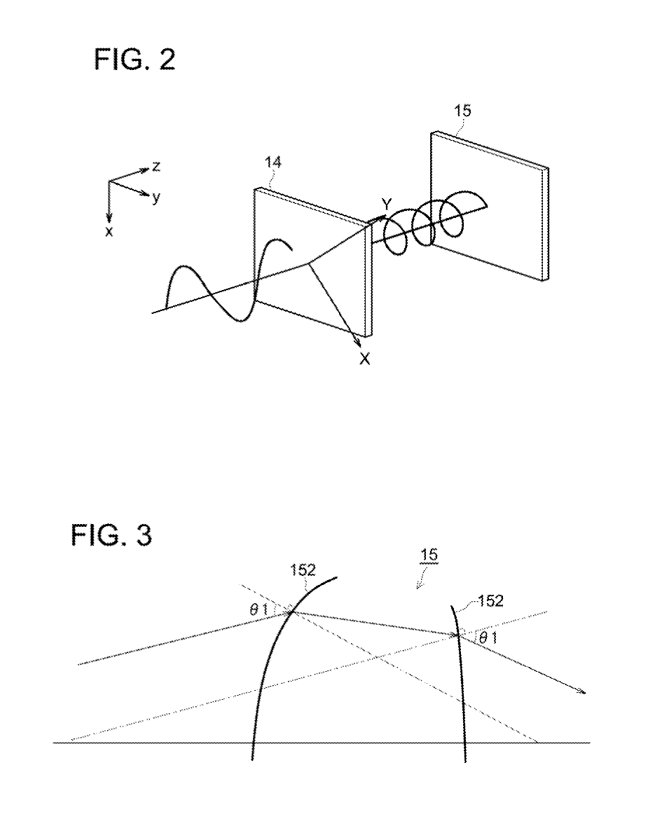

Next, as shown in FIG. 2, the P-polarized laser light is converted to right-circular-polarized light with the ¼ wavelength plate 14 and then converged with the objective lens 15 and enters into the information recording surface A of the information recording medium R at various incident angles, and a converged spot is thereby formed. At this time, as shown in FIG. 3, the maximum angle θ1 that is formed by the normal of the optical functional surface 152 of the objective lens 15 and the laser light flux with wavelength λ1 satisfy the expression of 40°≦θ1≦70°. In addition, the object lens 15 performs focusing operation and tracking operation with the actuator arranged around the objective lens.

Next, the circular-polarized laser light flux that forms the converged spot is reflected on the information recording surface A of the information recording medium R and converted to left-circular-polarized light after passing through the objective lens again. Then, the reflected light flux is converted to the straight-polarized light (S-polarized light) which includes only the S-polarized component, by the ¼ wavelength plate 14. Next, the S-polarized laser light flux is subjected to total reflection by the polarized beam splitter 13 and then converged in the photodetector 17 by the convex lens 16. In addition, by using the output signal of the photodetector 17, the information in the information recording medium R can be reproduced.

Next, the relationship between a phase of a laser light flux and a light loss amount during the above operation will be described.

First, the straight-polarized (P-polarized) laser light-flux (electric field) Eᵢₙ that has passed through the polarized beam splitter 13 and then has entered in the ¼ wavelength plate 14 can generally be represented by the following Equation 1 in the x-y-z coordinate system shown in FIG. 2. In the expression, “a” is a coefficient; “ω” is a coefficient represented by ω=2π ν (ν is the oscillation number of light); and t is a variable which represents time.

$${E}_{i n} = ( \begin{matrix}{E}_{x} \\ {E}_{y}\end{matrix} ) = a ( \begin{matrix}cos ω t \\ 0\end{matrix} ) \qquad ( 1 )$$

In the X-Y coordinate system in which the x axis and the y axis respectively are inclined at 45°, Equation (1) is represented by the following Equation (2).

$${E}_{i n} = ( \begin{matrix}{E}_{X} \\ {E}_{Y}\end{matrix} ) = ( \begin{matrix}cos θ & sin θ \\ - sin θ & cos θ\end{matrix} ) \times ( \begin{matrix}{E}_{x} \\ {E}_{y}\end{matrix} ) = \frac{a}{\sqrt{2}} ( \begin{matrix}cos ω t \\ - cos ω\end{matrix} ) \qquad ( 2 )$$

Next, the straight-polarized (P-polarized) laser light flux passes through the ¼ wavelength plate 14 and is converted to circular-polarized light. At this time, the phase of the Y-direction component is delayed by π/2 which is equivalent to ¼ wavelength, and thus the light which has passed through the ¼ wavelength plate 14 is represented by the following Equation (3).

$${E}_{mid} = ( \begin{matrix}{E}_{X} \\ {E}_{Y}\end{matrix} ) = \frac{a}{\sqrt{2}} ( \begin{matrix}cos ω t \\ - sin ω\end{matrix} ) \qquad ( 3 )$$

Equation (3) in the x-y coordinate system is represented by the following Equation (4).

$${E}_{mid} = ( \begin{matrix}{E}_{x} \\ {E}_{y}\end{matrix} ) = \frac{a}{\sqrt{2}} ( \begin{matrix}cos ( ω t - π / 4 ) \\ cos ( ω t + π / 4 )\end{matrix} ) \qquad ( 4 )$$

Next, the circular-polarized laser light flux passes the objective lens 15. At this time, if the phase of the y-direction component is delayed by Δδ when the laser light flux is emitted from the objective lens 15 compared with when the laser light flux enters into the objective lens 15, the light which has passed through the objective lens 15 is represented by the following Equation (5).

$${E}_{mid} = ( \begin{matrix}{E}_{x} \\ {E}_{y}\end{matrix} ) = \frac{a}{\sqrt{2}} ( \begin{matrix}cos ( ω t - π / 4 ) \\ cos ( ω t + π / 4 - Δδ )\end{matrix} ) \qquad ( 5 )$$

Next, this laser light flux is reflected on the information recording medium R and passes through the objective lens 15 again. At that time, the phase of the y-direction component is further delayed by Δδ when the laser light flux is emitted from the objective lens 15 compared with when the laser light flux enters into the objective lens 15. Therefore, the light which has passed through the objective lens 15 is represented by the following Equation (6).

$${E}_{ref} = ( \begin{matrix}{E}_{x} \\ {E}_{y}\end{matrix} ) = \frac{a}{\sqrt{2}} ( \begin{matrix}cos ( ω t - π / 4 ) \\ cos ( ω t + π / 4 - 2 Δδ )\end{matrix} ) \qquad ( 6 )$$

Equation (6) in the X-Y coordinate system is represented by the following Equation (7).

$${E}_{ref} = ( \begin{matrix}{E}_{X} \\ {E}_{Y}\end{matrix} ) = a ( \begin{matrix}cos ( ω t - Δδ ) cos ( π / 4 - Δδ ) \\ - sin ( ω t - Δδ ) sin ( π / 4 - Δδ )\end{matrix} ) \qquad ( 7 )$$

Next, the light which has passed through the objective lens 15 further passes through the ¼ wavelength plate 14 and is converted to straight-polarized light (S-polarized light). At this time, the phase of the Y-direction component is further delayed by π/2, and thus the light which has passed through the ¼ wavelength plate 14 is represented by the following Equation (8).

$${E}_{out} = ( \begin{matrix}{E}_{x} \\ {E}_{y}\end{matrix} ) = a ( \begin{matrix}cos Δδ \\ sin Δδ\end{matrix} ) cos ( ω t - Δδ ) \qquad ( 8 )$$

The intensity Iₒᵤₜ of the laser light flux of Equation (8) is represented by the following Equation (9) by squaring the amplitude of each component of Equation (8).

$${I}_{out} = ( \begin{matrix}{I}_{x} \\ {I}_{y}\end{matrix} ) = {a}^{2} ( \begin{matrix}{sin}^{2} Δδ \\ {cos}^{2} Δδ\end{matrix} ) \qquad ( 9 )$$

Then, this laser light flux (S-polarized light) is reflected by the polarized beam splitter 13 and converged on the photodetector. However, at this time, the converged laser light flux includes the component that was not converted to S-polarized light at the ¼ wavelength plate 14 due to its phase delay, and the component of the laser light flux passes through the polarized beam splitter 13. The intensity I_{LD} of the light which has passed through the polarized beam splitter 13, in other words the amount of light loss, is represented by the following Equation (10).

I_{LD}=α²sin²Δδ (10)

As can be seen from the above description, it is clear that the amount of light loss changes due to the phase delay Δδ, in other words the change amount in the phase difference, when light passes through the entire of the objective lens 15. Specific numerical values will be given in the following explanation for reference. When the phase delay Δδ of light which has passed through the entire of the objective lens 15 is assumed to be 20°, the light amount of 11.6% will be lost in the entire optical pickup apparatus 1. Further, when the phase delay is 6° or less when light has passed through one antireflection film provided on the objective lens 15, the amount of light loss is 4% or less. When the phase delay is 4° or less, the amount of light loss is 2% or less. When the phase delay is 1° or less, the amount of light loss is 1% or less. The amount of light loss becomes amount of light that returns to the laser light source. When the amount of light loss exceeds 4%, there is an adverse effect on the oscillation of the laser and this leads to unstable oscillation of laser beams such as wavelength drift or noise. Therefore, by controlling the phase delay of light which has passed through one antireflection film provided on the objective lens 15 or which has passed through the entire of the objective lens 15, to 6° or less, the amount of the return light becomes 4% or below. Therefore, the unstable oscillation of laser beams can be prevented. The return light to the laser is preferably 2% or less and more preferably 1% or less.

Next, the structure of the objective lens 15 will be described.

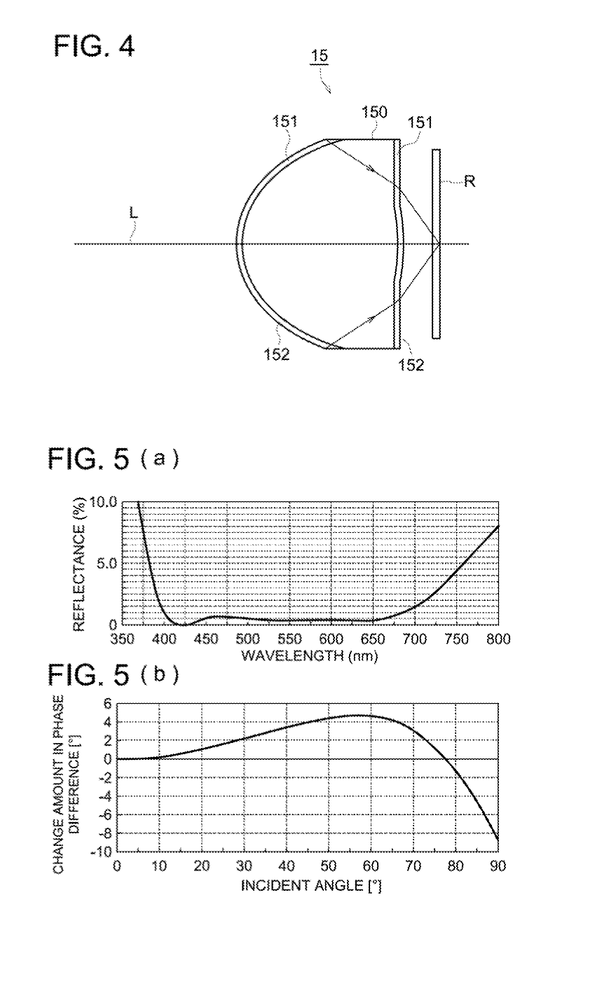

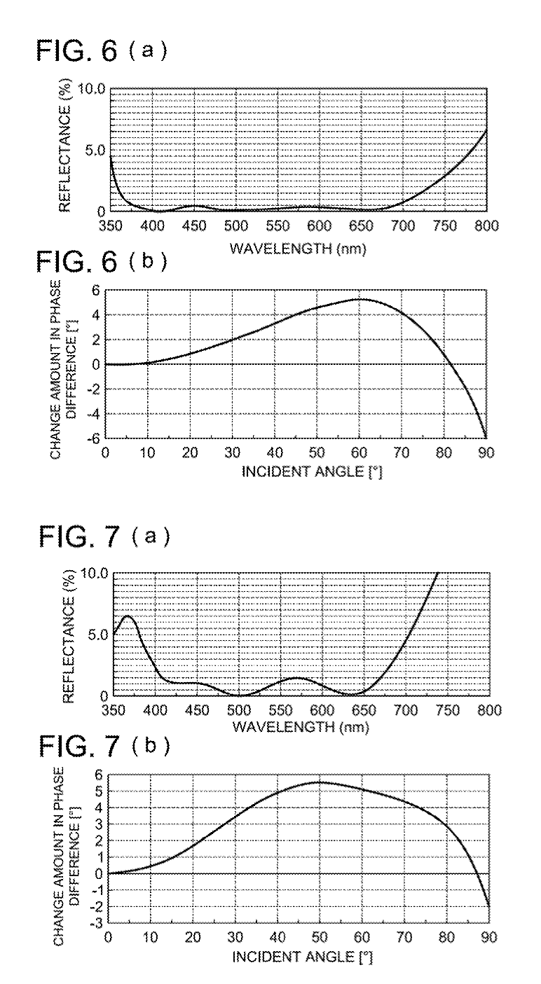

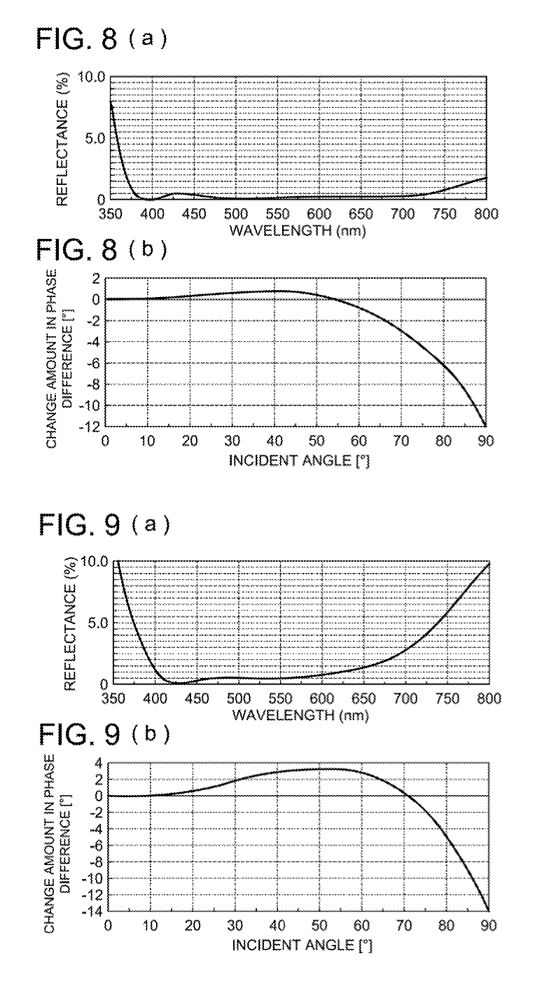

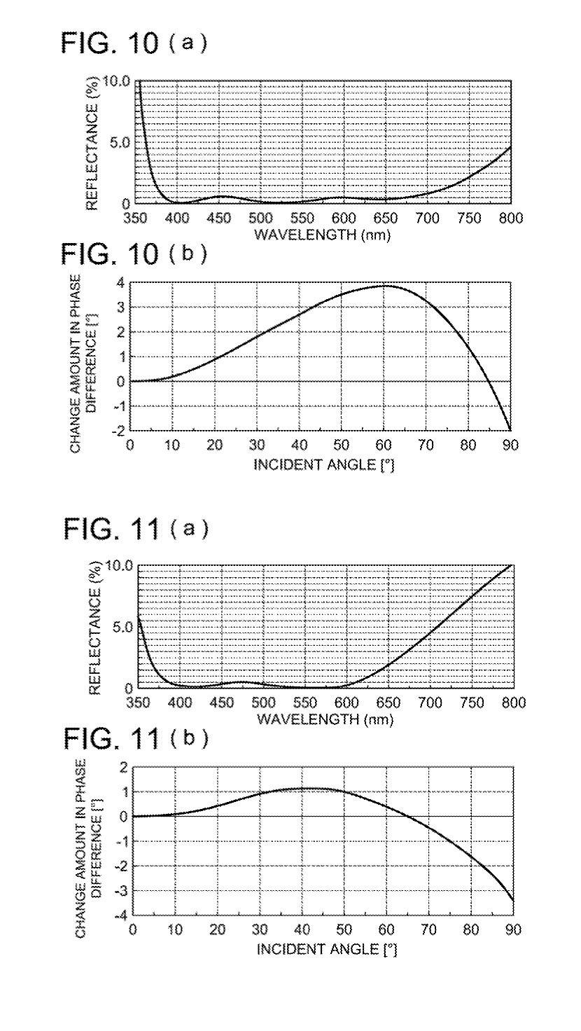

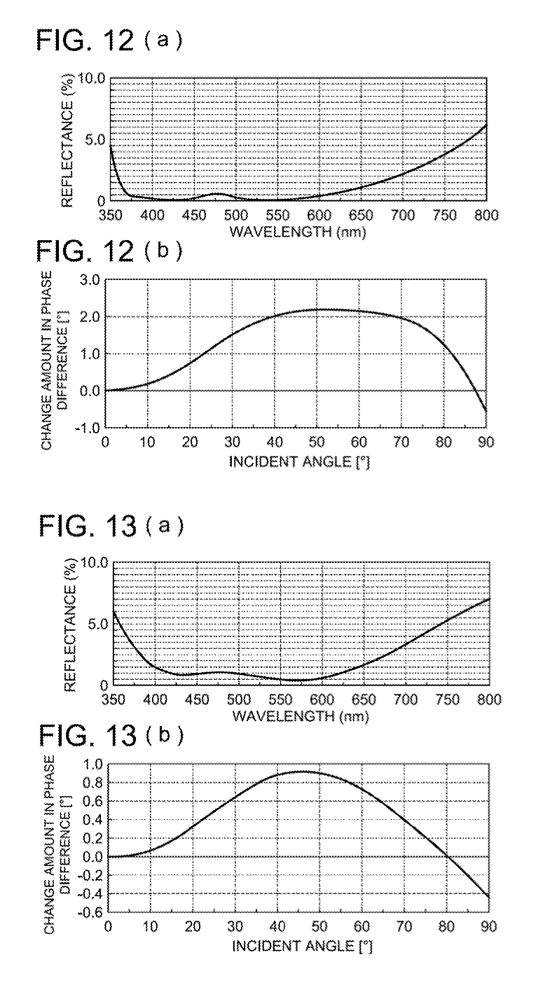

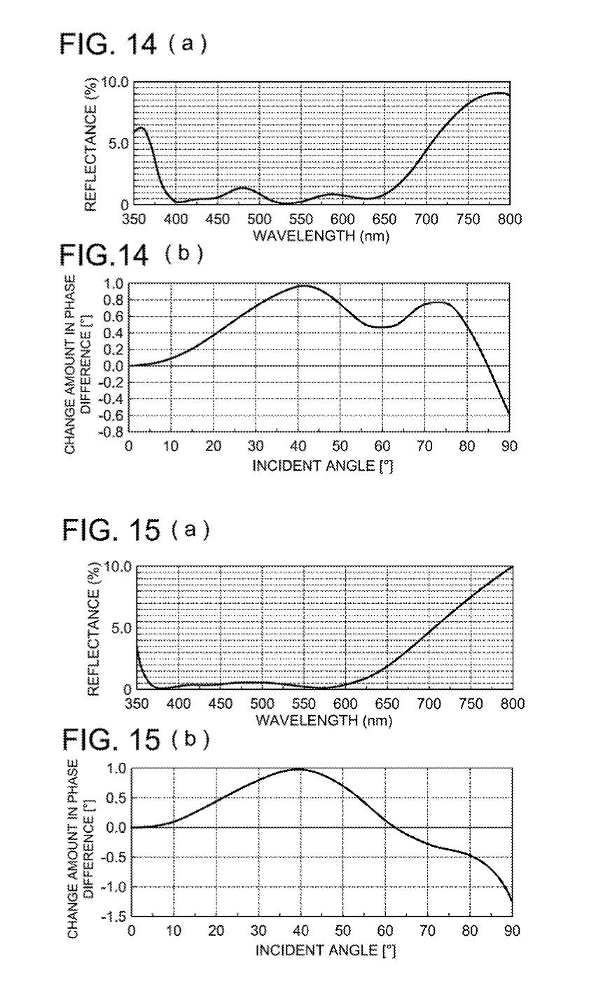

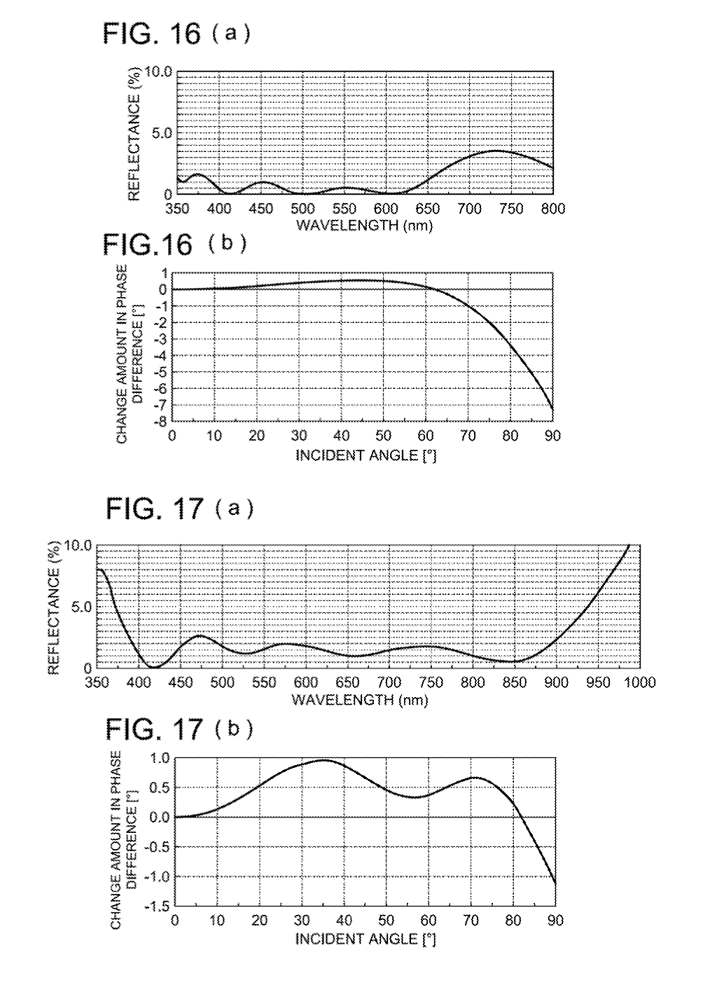

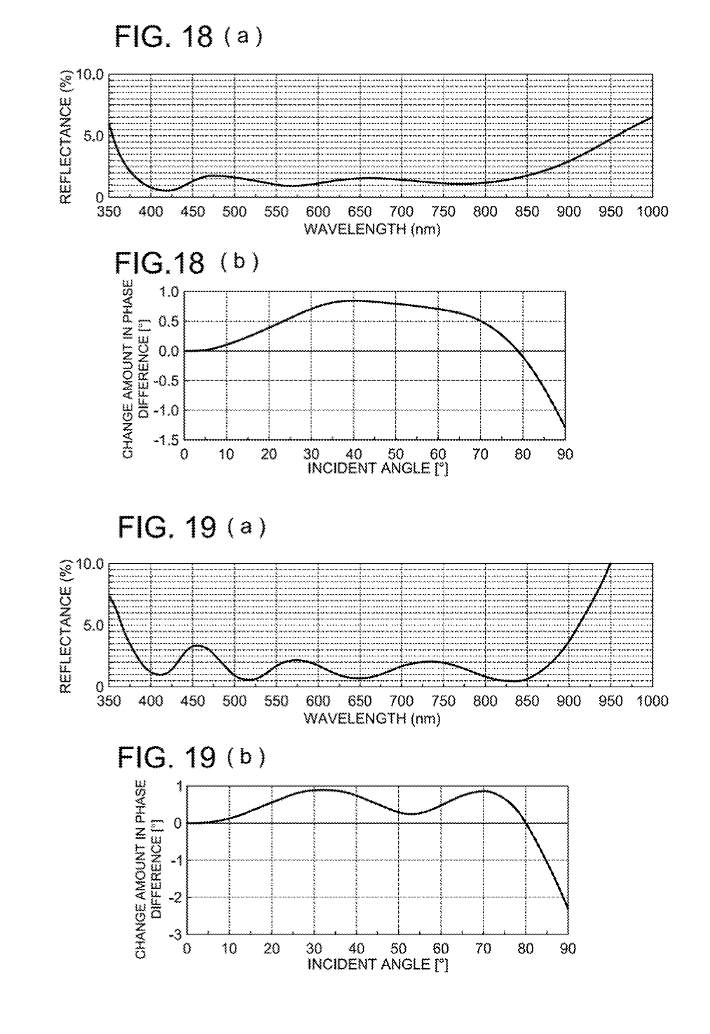

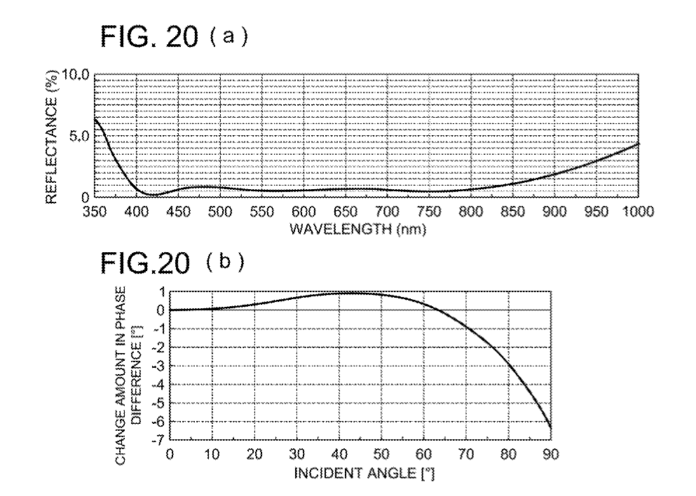

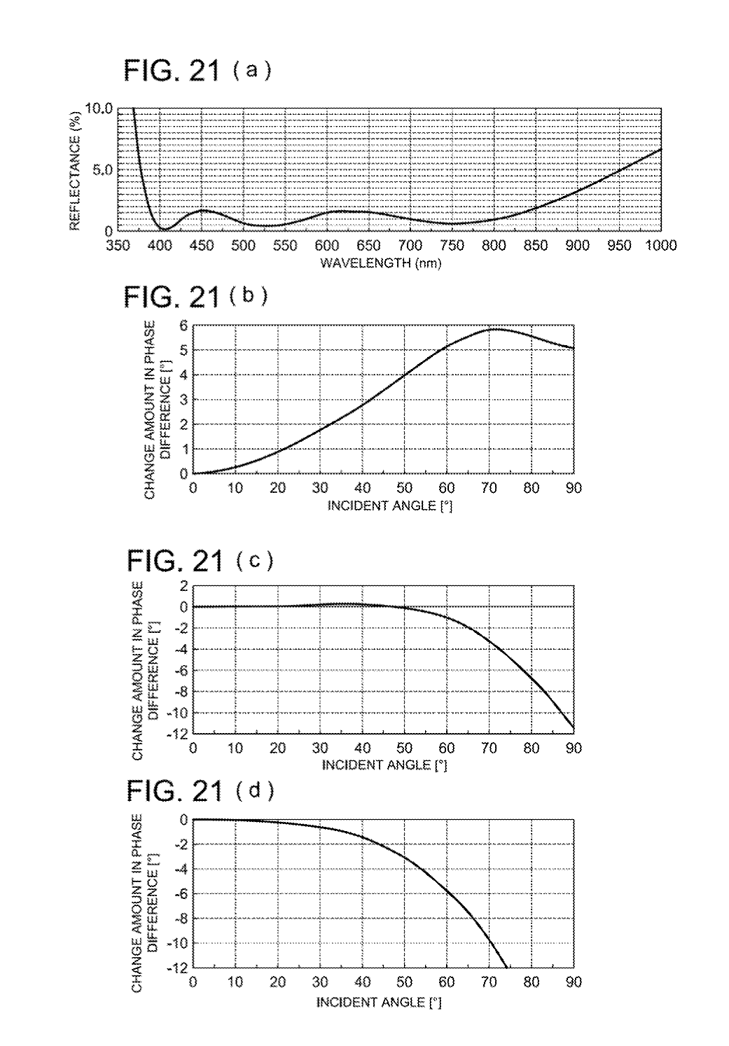

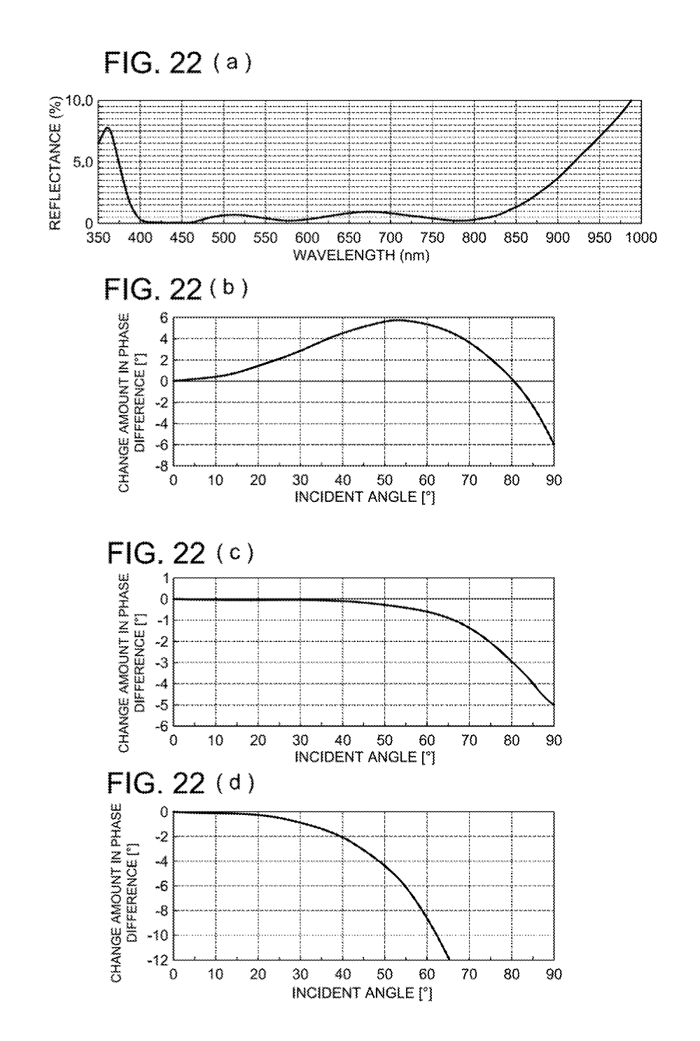

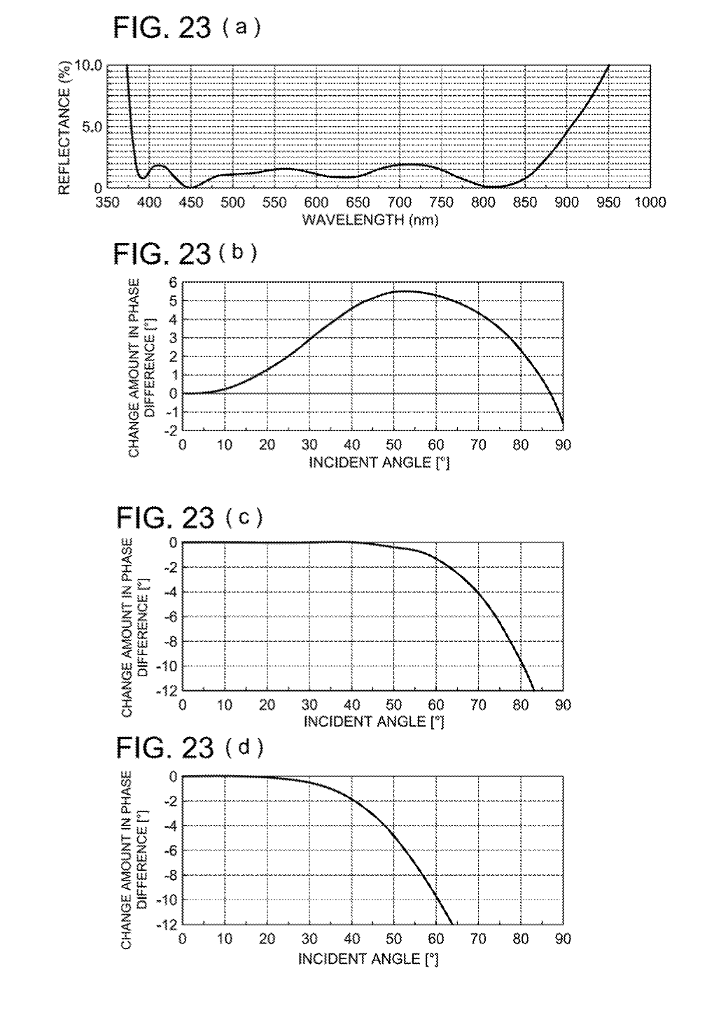

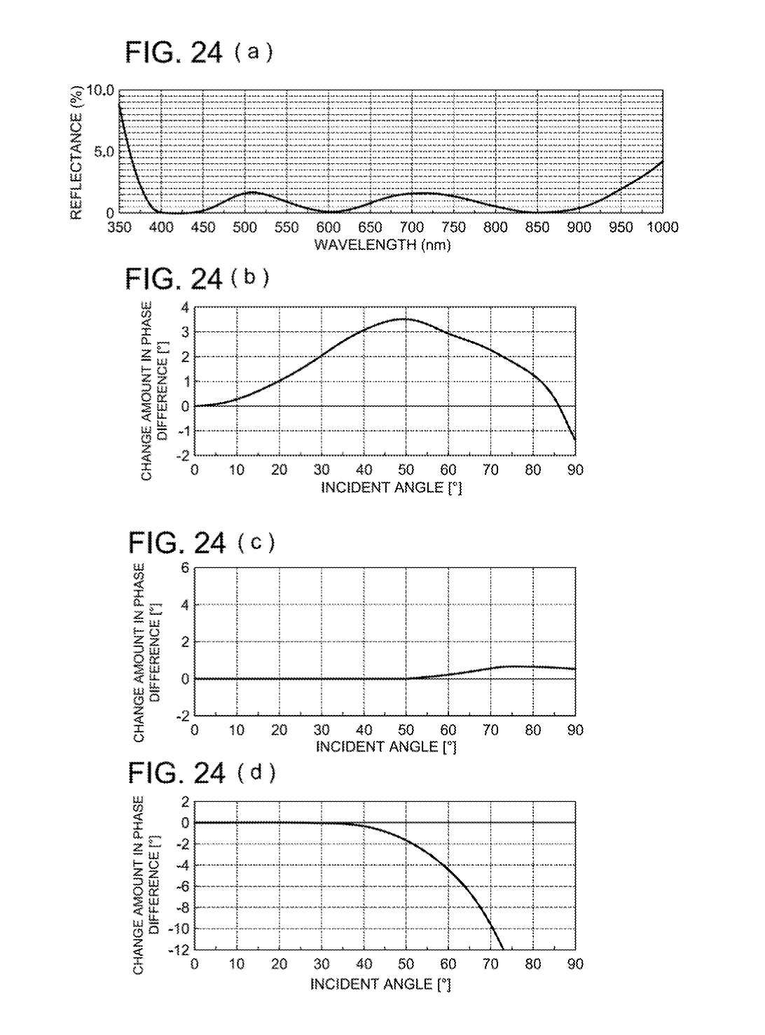

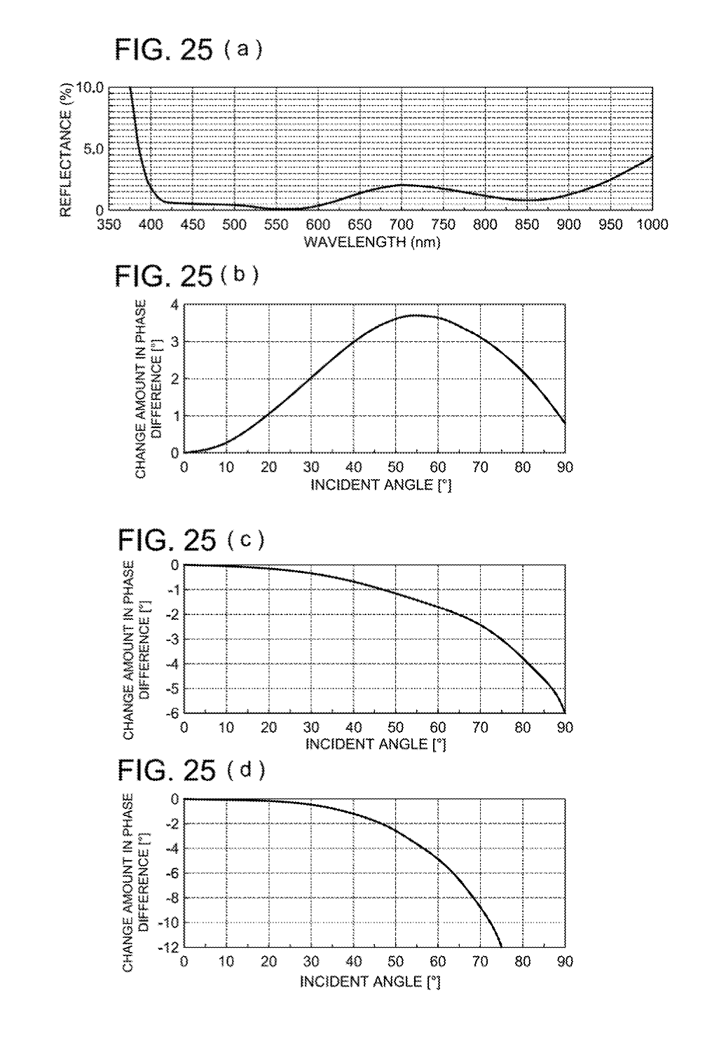

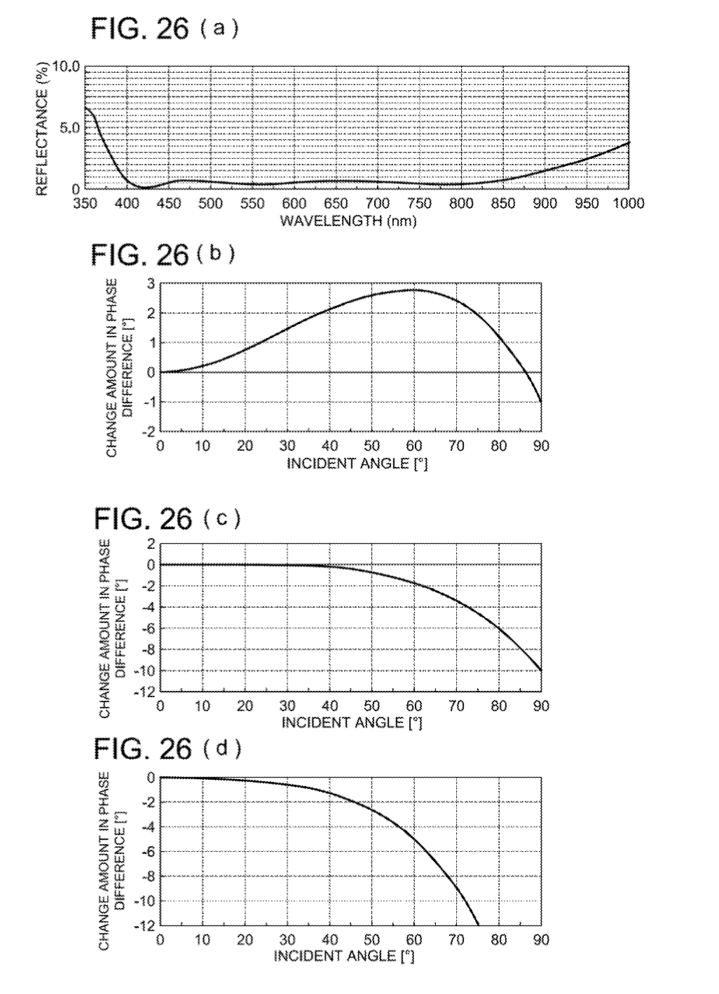

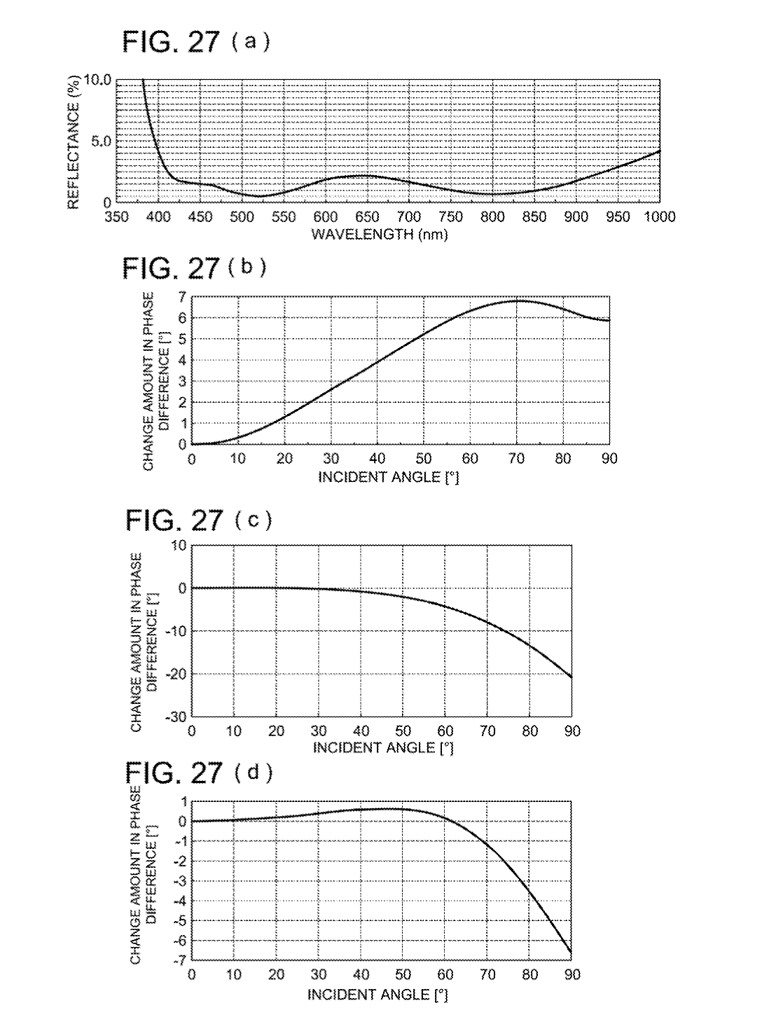

The objective lens 15 is an optical element relating to the present invention. As shown in FIG. 4, the objective lens in this embodiment is a simple lens including one lens body 150.

In this embodiment, the two opposite optical surfaces of the lens body 150 are both aspherical surfaces. It is to be noted that each optical surface may have a diffractive structure that is known heretofore.

The lens body 150 is molded from a plastic material that has excellent light and heat resistance with respect to short wavelength violet light. Examples of this type of plastic material include a resin compositions including a resin formed from copolymers of α-olefin and cyclic olefins, and a light-resistance stabilizer.

In this embodiment, each of two opposite surfaces of the lens body 150 has an antireflection film 151 and an optical functional surface 152 is formed thereon. If the antireflection film 151 is provided on at least one surface of the lens body 150, high transmittance can be maintained while the shape of the beam spot can be kept favorable. However, by providing the antireflection film on each of the surfaces of the lens main body 150, the effects of of the present invention can be more effectively obtained, which is preferable.

When the maximum angle formed by the laser light flux with wavelength λ1 and the normal of the optical functional surface 152 which is formed at the antireflection film 151 is 40°≦θ1≦70°, the objective lens 15 in the present embodiment makes the phase difference between a phase Pp1 of a P-polarized light and a phase Ps1 of a S-polarized light of the laser light flux when the laser light flux enters into the objective lens 15 substantially same to the phase difference when the laser light flux emitted from the objective lens 15. At that time, it is preferable that when the maximum angle formed by the laser light flux with wavelength λ1 and the normal of the optical functional surface 152 which is formed at the antireflection film 151 is 40°≦θ1≦70°, the antireflection film 151 makes the a phase difference between a phase Pp1 of a P-polarized light and a phase Ps1 of a S-polarized light of the laser light flux when the laser light flux enters into the antireflection film 151 substantially same to the phase difference between a phase Pp1 of a P-polarized light and a phase Ps1 of a S-polarized light when the laser light flux emitted from the antireflection film 151.

Here, “the phase difference between the phase Pp1 and the phase Ps1 when the laser light flux enters into the antireflection film 151 (objective lens 15) is substantially same to the phase difference when the laser light flux emitted from the antireflection film 151 (objective lens 15)” means that, with respect to the antireflection film 151, |Δ1|≦6° is satisfied where Δ1 is a change amount in the phase difference from when the laser light flux enters into the antireflection film 151, to when the laser light flux is emitted from the antireflection film 151. It means preferably |Δ1|≦4°, and more preferably |Δ1|≦1°. Similarly, with respect to the objective lens 15, it means that |Δ4|≦6° is satisfied where Δ4 is a change amount in the phase difference from when the laser light flux enters into the objective lens 15, to when the laser light flux is emitted from the objective lens 15. It means preferably |Δ4|≦4°, and more preferably |Δ4|≦1°.

The antireflection film 151 is formed from at least two types of materials or at least three types of materials. Herein, the refractive index of each material for light with wavelength 500 nm in the above antireflection film 151 represented by “n”. The at least two types of materials includes at least one of a lower refractive index materials satisfying 1.3≦n<1.55 and at least one of a higher refractive index materials satisfying 1.8≦n<2.5. The at least three types of materials includes at least one of the lower refractive index materials, at least one of the higher refractive index materials, and at least one of a middle refractive index materials satisfying 1.55≦n<1.8.

When the antireflection film 151 is formed of at least two materials which include the lower refractive index material and the higher refractive index material, it is preferable that the antireflection film 151 is formed of a plurality of layers whose numbers in the range of 5 to 11, and that the difference δ in refractive index between neighboring layers is 0.4≦δ≦0.55 for light with a wavelength of 500 nm. In addition, it is more preferable that the antireflection film 151 is formed by alternately layering a lower refractive index layer that is formed from the lower refractive index material and a higher refractive index layer that is formed from the higher refractive index material.

On the other hand, when the antireflection film 151 is formed from at least three types of materials which includes the lower refractive index material, the higher refractive index material and the medium refractive index material, it is preferable that the antireflection film 151 is formed of a plurality of layers including lower refractive index layers formed from the lower refractive index material, middle refractive index layers formed from the middle refractive index material, and the higher refractive index layers formed from the higher refractive index material.

In the embodiment, the lower refractive index material preferably includes MgF₂ or SiO₂ as the main component and more preferably includes SiO₂ as the main component. The medium refractive index material herein preferably includes Al₂O₃ as the main component. The higher refractive index material preferably includes TiO₂, Ta₂O₅, CeO₂, ZrO₂, HfO₂, La₂O₃, Nb₂O₅, or TiLaOx as a main component and more preferably includes TiO₂, Ta₂O₅, CeO₂, ZrO₂, or HfO₂ as the main component. The higher refractive index material further more preferably includes ZrO₂ or HfO₂ as the main component.

The main component herein refers to a component whose amount is 90 wt % or more of the total weight in each layer of the antireflection film 151.

It is to be noted that methods such as vapor deposition or sputtering, CVD or coating may be used to form this type of antireflection film 151.

In addition, an undercoat layer known heretofore may be placed between the lens body 150 and the antireflection film 151 in order to improve adhesion of the antireflection film 151 to the lens body 150. In addition, a staining proofing layer or a water repelling layer may be provided at the surface side of the antireflection film 151, and an antistatic layer may also be provided to prevent attachment of dust and foreign particles due to static electricity.

According to the objective lens 15 described above, the maximum angle θ1 formed by the normal of the optical functional surface 152 that is formed on the antireflection film 151 and the laser light flux with wavelength λ1 satisfies 40°≦θ1≦70°, and the phase difference between a phase Pp1 of a P-polarized light and a phase Ps1 of a S-polarized light of the laser light flux when the laser light flux enters into the objective lens 15 or the antireflection film 151 is the substantially same to the phase difference when the laser light flux is emitted from the objective lens 15 or the antireflection film 151. More specifically, the change amount Δ4 satisfies |Δ4|≦6°, preferably |Δ4|≦4°, and more preferably |Δ4|≦1°, where the change amount Δ4 is a change amount in a phase difference between a phase Pp1 of a P-polarized light and a phase Ps1 of a S-polarized light of the laser light flux from when the laser light flux enters into the objective lens 15 to when the laser light flux is emitted from the objective lens 15. Thus, the shape of the beam spot can be kept favorable. In other words, warping of the signal recorded on the information recording medium or the signal reproduced from the information recording medium can be reduced. At that time, the change amount Δ1 preferably satisfies |Δ1|≦6°, more preferably |Δ1|≦4°, and further more preferably |Δ1|≦1°, where the change amount Δ1 is a change amount in a phase difference between a phase Pp1 of a p-polarized light and a phase Ps1 of a S-polarized light of the laser light flux from when the laser light flux enters into the antireflection film 151 to when the laser light flux is emitted from the antireflection film 151.

Further, because at least one surface of the lens body 150 includes the antireflection film 151, high transmittance can be maintained. Furthermore, phase delay of the objective lens 15 as described above can be prevented, and it can reduce the amount of light loss due to the return light from the information recording medium R having passing through the polarized beam splitter 13. Thus, reduction of signal intensity can be prevented.

As a result, more accurate recording and/or reproduction of information than before becomes possible.

In the above embodiment, the optical pickup apparatus 1 converges a laser light flux with a wavelength of λ1 on an information recording medium R such as a BD or ED-DVD using the objective lens 15. However, using techniques known heretofore, the optical pickup apparatus may converge a laser light flux with wavelength λ2 (630 nm≦λ2≦670 nm) and a laser light flux with wavelength λ3 (760 nm≦λ3≦820 nm) on a CD and DVD, respectively. In this case, the maximum angle θ2 which is formed by the laser light flux with wavelength λ2 and the normal of the optical functional surface 152 formed on the antireflection film 151 may satisfy 40°≦θ2≦60° and the maximum angle θ3 which is formed on the laser light flux with wavelength λ3 and the normal of the optical functional surface 152 may satisfy 40°≦θ3≦50°. In addition, it is preferable that when the maximum angle θ2 is 40°≦θ2≦60°, the antireflection film 151 makes the phase difference between the phase difference between a phase Pp2 of a P-polarized light and a phase Ps2 of a S-polarized light of the laser light flux with the wavelength λ2 when the laser light flux with the wavelength λ2 enters into the antireflection film 151, substantially same to the phase difference when the laser light flux with the wavelength λ2 is emitted from the antireflection film 151. Also it is preferable that when the maximum angle θ3 is 40°≦θ3≦50°, the antireflection film 151 makes the phase difference between the phase difference between a phase Pp3 of a P-polarized light and a phase Ps3 of a S-polarized light of the laser light flux with the wavelength λ3 when the laser light flux with the wavelength λ3 enters into the antireflection film 151, substantially same to the phase difference when the laser light flux with the wavelength λ3 is emitted from the antireflection film 151. As a result, it is preferable that when the maximum angle θ1 satisfies 40°≦θ1≦70°, the objective lens 15 makes the phase difference between a phase Pp1 of a P-polarized light and a phage Ps1 of a S-polarized light of the laser light flux with the wavelength λ1 when the laser light flux enters into the objective lens 15, substantially same to the phase difference when the laser light flux is emitted from the objective lens 15; and that when the maximum angle θ2 is 40°≦θ2≦60°, the objective lens 15 makes the phase difference between a phase Pp2 of a P-polarized light and a phase Ps2 of a S-polarized light of the laser light flux with the wavelength λ2 when the laser light flux enters into the objective lens 15, substantially same to the phase difference when the laser light flux is emitted from the objective lens 15; and that when the maximum angle θ3 is 40°≦θ3≦50°, the objective kens 15 makes the phase difference between a phase Pp3 of a P-polarized light and a phase Ps3 of a S-polarized light of the laser light flux with the wavelength λ3 when the laser light flux enters into the objective lens 15, substantially same to the phase difference when the laser light flux is emitted from the objective lens 15.

Here, “the phase difference between the phase Pp2 and the phase Ps2 when the laser light flux enters into the antireflection film 151 (objective lens 15) is substantially same to the phase difference when the laser light flux emitted from the antireflection film 151 (objective lens 15)” means that, with respect to the antireflection film 151, |Δ2|≦6° is satisfied where Δ2 is a change amount in the phase difference from when the laser light flux with wavelength λ2 enters into the antireflection film 151, to when the laser light flux is emitted from the antireflection film 151. It means preferably |Δ2|≦4°, and more preferably |Δ2|≦1°. Similarly, with respect to the objective lens 15, it means that |Δ5|≦6° is satisfied where Δ5 is a change amount in the phase difference from when the laser light flux with wavelength λ2 enters into the objective lens 15, to when the laser light flux is emitted from the objective lens 15. It means preferably |Δ5|≦4°, and more preferably |Δ5|≦1°.

Further, “the phase difference between the phase Pp3 and the phase Ps3 when the laser light flux enters into the antireflection film 151 (objective lens 15) is substantially same to the phase difference when the laser light flux emitted from the antireflection film 151 (objective lens 15)” means that, with respect to the antireflection film 151, |Δ3|≦5° is satisfied where Δ3 is a change amount in the phase difference from when the laser light flux with wavelength λ3 enters Into the antireflection film 151, to when the laser light flux is emitted from the antireflection film 151. It means preferably |Δ3|≦4°, and more preferably |Δ3|≦1°. Similarly, with respect to the objective lens 15, it means that |Δ6|≦6° is satisfied where Δ6 is a change amount in the phase difference from when the laser light flux with wavelength λ6 enters into the objective lens 15, to when the laser light flux is emitted from the objective lens 15. It means preferably |Δ6|≦4°, and more preferably |Δ6|≦1°.

In the above embodiment, the optical element relating to the present invention is the objective lens 15, but collimator lens or beam expander and the like may be utilized as the optical element.

Further, in the above embodiment, the objective lens 15 that has been described has only one lens body 150, but it may also have two or more lens bodies.

### EXAMPLES

The present invention is described more specifically below using examples and a Comparative Example.

### Example 1

### <Structure of the Objective Lens>

The objective lenses having the structures shown in the following Tables 1 through 16 were formed as Examples (1)-(16) of the objective lens 15 in the above embodiment.

The objective lens 15 of each Example converges laser light with a wavelength of λ1 on an information recording medium R such as BD or HD-DVD.

The configuration of the lens body 15 can be a configuration known heretofore. In the following Tables, “Lens” in the “Layer” column refers to the lens body 150 and the numbers “1”, “2” . . . in the “Layer” column indicate layers of the antireflection film 151. The names “L5” and “M3” in the material column indicate the vapor deposition material “SUBSTANCE M3” and “SUBSTANCE L5” (trade names) manufactured by Merck Ltd., Japan and the name “OA600” (trade name) is vapor deposition material manufactured by CANON OPTRON INC. The letters “A” and “B” following the material name indicate that the vapor deposition conditions for changing the refractive index are different. The value of refractive index is the refractive index for laser light with a wavelength of 500 nm.

TABLE 1

| | | Refractive | |
|---|---|---|---|
| Layer | Material | Index | Thickness |
| Air | | 1 | |
| 5 | MgF₂ | 1.39 | 89.04 |
| 4 | TiO₂ | 2.30 | 105.21 |
| 3 | MgF₂ | 1.39 | 33.66 |
| 2 | TiO₂ | 2.30 | 11.7 |
| 1 | MgF₂ | 1.39 | 153.54 |
| Lens | Polyolefin | 1.55 | |
| | resin | | |

TABLE 2

| | | Refractive | |
|---|---|---|---|
| Layer | Material | Index | Thickness |
| Air | | 1 | |
| 9 | MgF₂ | 1.39 | 79.99 |
| 8 | TiO₂ | 2.30 | 8.28 |
| 7 | MgF₂ | 1.39 | 6.47 |
| 6 | TiO₂ | 2.30 | 7.85 |
| 5 | MgF₂ | 1.39 | 4.48 |
| 4 | TiO₂ | 2.30 | 86.96 |
| 3 | MgF₂ | 1.39 | 27.39 |
| 2 | TiO₂ | 2.30 | 13.18 |
| 1 | MgF₂ | 1.39 | 163.71 |
| Lens | Polyolefin | 1.55 | |
| | resin | | |

TABLE 3

| | | Refractive | |
|---|---|---|---|
| Layer | Material | Index | Thickness |
| Air | | 1 | |
| 11 | MgF₂ | 1.39 | 76.36 |
| 10 | TiO₂ | 2.30 | 15 |
| 9 | MgF₂ | 1.39 | 9.18 |
| 8 | TiO₂ | 2.30 | 113.58 |
| 7 | MgF₂ | 1.39 | 10 |
| 6 | TiO₂ | 2.30 | 61.16 |
| 5 | MgF₂ | 1.39 | 10 |
| 4 | TiO₂ | 2.30 | 34 |
| 3 | MgF₂ | 1.39 | 25.8 |
| 2 | TiO₂ | 2.30 | 15 |
| 1 | MgF₂ | 1.39 | 160.71 |
| Lens | Polyolefin | 1.55 | |
| | resin | | |

TABLE 4

| | | Refractive | |
|---|---|---|---|
| Layer | Material | Index | Thickness |
| Air | | 1 | |
| 11 | MgF₂ | 1.39 | 88.94 |
| 10 | TiO₂ | 2.30 | 14.26 |
| 9 | MgF₂ | 1.39 | 6.23 |
| 8 | TiO₂ | 2.30 | 11.88 |
| 7 | MgF₂ | 1.39 | 7.28 |
| 6 | TiO₂ | 2.30 | 71.85 |
| 5 | Al₂O₃-A | 1.62 | 13.29 |
| 4 | TiO₂ | 2.30 | 13.22 |
| 3 | Al₂O₃-A | 1.62 | 15.56 |
| 2 | TiO₂ | 2.30 | 9.22 |
| 1 | Al₂O₃-A | 1.62 | 62.1 |
| Lens | Polyolefin | 1.55 | |
| | resin | | |

TABLE 5

| | | Refractive | |
|---|---|---|---|
| Layer | Material | Index | Thickness |
| Air | | 1 | |
| 5 | MgF₂ | 1.39 | 86 |
| 4 | TiO₂ | 2.30 | 101.15 |
| 3 | MgF₂ | 1.39 | 33.97 |
| 2 | TiO₂ | 2.30 | 9.77 |
| 1 | MgF₂ | 1.39 | 171.06 |
| Lens | Polyolefin | 1.55 | |
| | resin | | |

TABLE 6

| | | Refractive | |
|---|---|---|---|
| Layer | Material | Index | Thickness |
| Air | | 1 | |
| 7 | MgF₂ | 1.39 | 78.55 |
| 6 | TiO₂ | 2.30 | 9.87 |
| 5 | MgF₂ | 1.39 | 5.26 |
| 4 | TiO₂ | 2.30 | 97.66 |
| 3 | MgF₂ | 1.39 | 31.21 |
| 2 | TiO₂ | 2.30 | 13.14 |
| 1 | MgF₂ | 1.39 | 160.36 |
| Lens | Polyolefin | 1.55 | |
| | resin | | |

TABLE 7

| | | Refractive | |
|---|---|---|---|
| Layer | Material | Index | Thickness |
| Air | | 1 | |
| 5 | SiO₂-A | 1.46 | 81.12 |
| 4 | OA600 | 2.06 | 64.59 |
| 3 | SiO₂-A | 1.46 | 15.32 |
| 2 | OA600 | 2.06 | 24.97 |
| 1 | SiO₂-A | 1.46 | 147.82 |
| Lens | Polyolefin | 1.55 | |
| | resin | | |

TABLE 8

| | | Refractive | |
|---|---|---|---|
| Layer | Material | Index | Thickness |
| Air | | 1 | |
| 7 | MgF₂ | 1.39 | 90.59 |
| 6 | H₄ | 2.11 | 42.33 |
| 5 | MgF₂ | 1.39 | 14.76 |
| 4 | H₄ | 2.11 | 39.24 |
| 3 | Al₂O₃-B | 1.63 | 101.66 |
| 2 | MgF₂ | 1.39 | 11.63 |
| 1 | Al₂O₃-B | 1.63 | 200 |
| Lens | Polyolefin | 1.55 | |
| | resin | | |

TABLE 9

| | | Refractive | |
|---|---|---|---|
| Layer | Material | Index | Thickness |
| Air | | 1 | |
| 5 | L5-B | 1.50 | 80.37 |
| 4 | ZrO₂-A | 1.90 | 73.84 |
| 3 | L5-B | 1.50 | 22.96 |
| 2 | ZrO₂-A | 1.90 | 18.98 |
| 1 | L5-B | 1.50 | 124.24 |
| Lens | Polyolefin | 1.55 | |
| | resin | | |

TABLE 10

| | | Refractive | |
|---|---|---|---|
| Layer | Material | Index | Thickness |
| Air | | 1 | |
| 11 | SiO₂-A | 1.46 | 82.51 |
| 10 | ZrO₂-A | 1.90 | 249.51 |
| 9 | SiO₂-A | 1.46 | 15.99 |
| 8 | ZrO₂-A | 1.90 | 7.79 |
| 7 | SiO₂-A | 1.46 | 6.96 |
| 6 | ZrO₂-A | 1.90 | 3.07 |
| 5 | SiO₂-A | 1.46 | 17.89 |
| 4 | ZrO₂-A | 1.90 | 7.88 |
| 3 | SiO₂-A | 1.46 | 174.57 |
| 2 | ZrO₂-A | 1.90 | 4.18 |
| 1 | SiO₂-A | 1.46 | 179.78 |
| Lens | Polyolefin | 1.55 | |
| | resin | | |

TABLE 11

| | | Refractive | |
|---|---|---|---|
| Layer | Material | Index | Thickness |
| Air | | 1 | |
| 7 | MgF₂ | 1.39 | 82.67 |
| 6 | CeO₂ | 1.94 | 40.37 |
| 5 | MgF₂ | 1.39 | 7.82 |
| 4 | CeO₂ | 1.94 | 33.22 |
| 3 | MgF₂ | 1.39 | 12.11 |
| 2 | CeO₂ | 1.94 | 17.79 |
| 1 | MgF₂ | 1.39 | 155.87 |
| Lens | Polyolefin | 1.55 | |
| | resin | | |

TABLE 12

| | | Refractive | |
|---|---|---|---|
| Layer | Material | Index | Thickness |
| Air | | 1 | |
| 11 | MgF₂ | 1.39 | 93.64 |
| 10 | H₄ | 2.11 | 33.32 |
| 9 | MgF₂ | 1.39 | 12.19 |
| 8 | H₄ | 2.11 | 78.66 |
| 7 | MgF₂ | 1.39 | 3.6 |
| 6 | H₄ | 2.11 | 226.61 |
| 5 | Al₂O₃-A | 1.62 | 13.77 |
| 4 | H₄ | 2.11 | 28.23 |
| 3 | Al₂O₃-A | 1.62 | 29.49 |
| 2 | H₄ | 2.11 | 6 |
| 1 | Al₂O₃-A | 1.62 | 20 |
| Lens | Polyolefin | 1.55 | |
| | resin | | |

TABLE 13

| | | Refractive | |
|---|---|---|---|
| Layer | Material | Index | Thickness |
| Air | | 1 | |
| 10 | L5-A | 1.47 | 81.75 |
| 9 | ZrO₂-A | 1.90 | 128.94 |
| 8 | L5-A | 1.47 | 10.87 |
| 7 | ZrO₂-A | 1.90 | 15.44 |
| 6 | L5-A | 1.47 | 168.68 |
| 5 | ZrO₂-A | 1.90 | 13.11 |
| 4 | L5-A | 1.47 | 22.18 |
| 3 | ZrO₂-A | 1.90 | 141.07 |
| 2 | L5-A | 1.47 | 20.33 |
| 1 | ZrO₂-A | 1.90 | 18.79 |
| Lens | Polyolefin | 1.55 | |
| | resin | | |

TABLE 14

| | | Refractive | |
|---|---|---|---|
| Layer | Material | Index | Thickness |
| Air | | 1 | |
| 5 | L5-B | 1.50 | 85.61 |
| 4 | ZrO₂-A | 1.90 | 142.86 |
| 3 | L5-B | 1.50 | 35.69 |
| 2 | ZrO₂-A | 1.90 | 14.97 |
| 1 | L5-B | 1.50 | 163.67 |
| Lens | Polyolefin | 1.55 | |
| | resin | | |

TABLE 15

| | | Refractive | |
|---|---|---|---|
| Layer | Material | Index | Thickness |
| Air | | 1 | |
| 11 | SiO₂-A | 1.46 | 77.21 |
| 10 | HfO₂ | 2.01 | 129.27 |
| 9 | SiO₂-A | 1.46 | 15.27 |
| 8 | HfO₂ | 2.01 | 10.14 |
| 7 | SiO₂-A | 1.46 | 168.86 |
| 6 | HfO₂ | 2.01 | 13.38 |
| 5 | SiO₂-A | 1.46 | 18.74 |
| 4 | HfO₂ | 2.01 | 129.68 |
| 3 | SiO₂-A | 1.46 | 17.54 |
| 2 | HfO₂ | 2.01 | 19.33 |
| 1 | SiO₂-A | 1.46 | 10 |
| Lens | Polyolefin | 1.55 | |
| | resin | | |

TABLE 16

| | | Refractive | |
|---|---|---|---|
| Layer | Material | Index | Thickness |
| Air | | 1 | |
| 7 | MgF₂ | 1.39 | 98.68 |
| 6 | OA600 | 2.06 | 19.3 |
| 5 | M3 | 1.74 | 24.24 |
| 4 | OA600 | 2.06 | 86.73 |
| 3 | M3 | 1.74 | 5 |
| 2 | OA600 | 2.06 | 7.81 |
| 1 | M3 | 1.74 | 71.05 |
| Lens | Polyolefin | 1.55 | |
| | resin | | |

### <Evaluation of Reflectance Properties>

The reflectance properties of the objective lens 15 of the Examples (1)-(16) formed as described above was measured, to obtain the results shown in FIG. 5(a), FIG. 6(a), through FIG. 20(a). These show that, in all of the objective lens 15, favorable transmittance was obtained for light in the wavelength region of 390 nm to 430 nm.

### <Evaluation of Change Amount in Phase Difference>

The change amounts Δ1 of Examples (1) to (16) were calculated by simulation to obtain the results shown in FIG. 5(b), FIG. 6(b), through FIG. 20(b). The film design software “Essential Macleod” manufactured by Sigma Koki Co., Ltd. was used for the simulation. In these Examples, the change amount Δ1 and the change amount Δ4 had the same values. Where, the change amounts Δ1 is a change amount in a phase difference between a phase Pp1 of P-polarized light and a phase Ps1 of S-polarized light of the laser light flux with a wavelength of Δ1, from when the laser light flux, enters into the antireflection film 151, to when the laser light flux is emitted from the antireflection film 151. The change amounts Δ4 is a change amount in a phase difference between a phase Pp1 of a P-polarized light and a phase Ps1 of a S-polarized light of the laser light flux with a wavelength of λ1, from when the laser light flux enters into the objective lens 15, to when the laser light flux is emitted from the objective lens 15.

It was seen that, in all of the objective lens 15, when the maximum angle θ1 formed by the normal of the optical functional surface formed on the antireflection film 151 and laser light flux with a wavelength λ1 is 40°≦θ1≦70°, the change amount Δ1 in the phase difference is |Δ1|≦6° and the change amount Δ4 in the phase difference is |Δ4|≦6°.

In Examples (9) to (16), each antireflection, film 151 is formed of any one of 5 to 11 layers formed from at least two kinds of materials including at least one material selected from the lower refractive index materials and at least one material selected from the higher refractive index materials, and the difference in refractive index δ between neighboring layers for light with a wavelength of 500 nm is 0.4≦δ≦0.55. It can be seen that, in these examples particularly, when the maximum angle θ1 is 40°≦θ1≦70°, the change amount Δ1 in phase difference is |Δ1|≦1° and the change amount Δ4 of phase difference is |Δ4|≦1°.

### Example 2

### <Structure of Objective Lens>

The objective lens having the structures shown in the following Tables 17 through 22 were formed as Examples (17)-(22) of the objective lens 15 in the above embodiment.

The objective lens 15 of each Examples converges laser light with, a wavelength of λ1 on an information, recording medium R such as BD or HD-DVD, converges laser light of the wavelength λ2 on DVD, and converges laser light of the wavelength λ3 on CD. The configuration of the lens body 15 can be a configuration known heretofore.

TABLE 17

| | | Refractive | |
|---|---|---|---|
| Layer | Material | Index | Thickness |
| Air | | 1 | |
| 7 | SiO₂-B | 1.49 | 95.16 |
| 6 | ZrO₂-B | 1.99 | 57.38 |
| 5 | SiO₂-B | 1.49 | 14.64 |
| 4 | ZrO₂-B | 1.99 | 55.74 |
| 3 | SiO₂-B | 1.49 | 46.14 |
| 2 | ZrO₂-B | 1.99 | 15.03 |
| 1 | SiO₂-B | 1.49 | 109.38 |
| Lens | Polyolefin | 1.55 | |
| | resin | | |

TABLE 18

| | | Refractive | |
|---|---|---|---|
| Layer | Material | Index | Thickness |
| Air | | 1 | |
| 11 | MgF₂ | 1.39 | 85.95 |
| 10 | TiO₂ | 2.30 | 19.54 |
| 9 | MgF₂ | 1.39 | 11.17 |
| 8 | TiO₂ | 2.30 | 102.07 |
| 7 | MgF₂ | 1.39 | 13.31 |
| 6 | TiO₂ | 2.38 | 8.14 |
| 5 | MgF₂ | 1.39 | 15.26 |
| 4 | TiO₂ | 2.30 | 7.34 |
| 3 | MgF₂ | 1.39 | 14.65 |
| 2 | TiO₂ | 2.30 | 5.09 |
| 1 | MgF₂ | 1.39 | 182.66 |
| Lens | Polyolefin | 1.55 | |
| | resin | | |

TABLE 19

| | | Refractive | |
|---|---|---|---|
| Layer | Material | Index | Thickness |
| Air | | 1 | |
| 9 | MgF₂ | 1.39 | 118.06 |
| 8 | H₄ | 2.11 | 16.29 |
| 7 | MgF₂ | 1.39 | 68.37 |
| 6 | H₄ | 2.11 | 10.23 |
| 5 | MgF₂ | 1.39 | 149.15 |
| 4 | Al₂O₃-B | 1.63 | 72.58 |
| 3 | H₄ | 2.11 | 127.02 |
| 2 | Al₂O₃-B | 1.63 | 102.12 |
| 1 | MgF₂ | 1.39 | 34.54 |
| Lens | Polyolefin | 1.55 | |
| | resin | | |

TABLE 20

| | | Refractive | |
|---|---|---|---|
| Layer | Material | Index | Thickness |
| Air | | 1 | |
| 11 | MgF₂ | 1.39 | 85.91 |
| 10 | OA600 | 2.06 | 16.3 |
| 9 | MgF₂ | 1.39 | 6.52 |
| 8 | OA600 | 2.06 | 10.23 |
| 7 | MgF₂ | 1.39 | 9.28 |
| 6 | OA600 | 2.06 | 112.41 |
| 5 | MgF₂ | 1.39 | 19.77 |
| 4 | OA600 | 2.06 | 12.44 |
| 3 | MgF₂ | 1.39 | 20.62 |
| 2 | OA600 | 2.06 | 11.97 |
| 1 | MgF₂ | 1.39 | 178.62 |
| Lens | Polyolefin | 1.55 | |
| | resin | | |

TABLE 21

| | | Refractive | |
|---|---|---|---|
| Layer | Material | Index | Thickness |
| Air | | 1 | |
| 5 | SiO₂-A | 1.46 | 91.89 |
| 4 | OA600 | 2.06 | 146.48 |
| 3 | SiO₂-A | 1.46 | 30.27 |
| 2 | OA600 | 2.06 | 21.61 |
| 1 | SiO₂-A | 1.46 | 179.41 |
| Lens | Polyolefin | 1.55 | |
| | resin | | |

TABLE 22

| | | Refractive | |
|---|---|---|---|
| Layer | Material | Index | Thickness |
| Air | | 1 | |
| 7 | MgF₂ | 1.39 | 96.82 |
| 6 | Ta₂O₅ | 2.10 | 23.37 |
| 5 | MgF₂ | 1.39 | 13.82 |
| 4 | Ta₂O₅ | 2.10 | 112 |
| 3 | Al₂O₃-A | 1.62 | 26.97 |
| 2 | Ta₂O₅ | 2.10 | 16.15 |
| 1 | Al₂O₃-A | 1.62 | 54.84 |
| Lens | Polyolefin | 1.55 | |
| | resin | | |

### <Evaluation of Reflectance Properties>

The reflectance properties of the objective lens 15 of the Examples (17)-(22) formed as described above was measured, to obtain the results shown in FIG. 21(a), FIG. 22(a), through FIG. 26(a). These show that in all of the objective lens 15, favorable transmittance was obtained for light in the wavelength regions of 390 nm to 430 nm, 630 nm to 670 nm and 760 nm to 820 nm.

### <Evaluation of Change Amount in Phase Difference>

The change amounts Δ1 of Examples (17)-(22) were calculated by simulation as was the case in Example 1 to obtain the results shown in FIG. 21(b), FIG. 22(b), through FIG. 26(b). In these Examples, the change amount Δ1 and the change amount Δ4 had the same values. Where, the change amounts Δ1 is a change amount in a phase difference between a phase Pp1 of P-polarized light and a phase Ps1 of S-polarized light of the laser light flux with a wavelength of λ1, from when the laser light flux enters into the antireflection film 151, to when the laser light flux is emitted from the antireflection film 151. The change amounts Δ4 is a change amount in a phase difference between a phase Pp1 of a p-polarized light and a phase Ps1 of a S-polarized light of the laser light flux with a wavelength of λ1, from when the laser light flux enters into the objective lens 15, to when the laser light flux is emitted from, the objective lens 115

Similarly, the change amounts Δ2 of Examples (17)-(22) were calculated by simulation to obtain the results shown in FIG. 21(c), FIG. 22(c), through FIG. 26(c). In these Examples, the change amount Δ2 and the change amount Δ5 had the same values. Where, the change amounts Δ2 is a change amount in a phase difference between a phase Pp2 of P-polarized light and a phase Ps2 of S-polarized light of the laser light flux with a wavelength of λ2, from when the laser light flux enters into the antireflection film 151, to when the laser light flux is emitted from the antireflection film 151. The change amounts Δ5 is a change amount in a phase difference between a phase Pp2 of a P-polarized light and a phase Ps2 of a S-polarized light of the laser light flux with a wavelength of λ2, from when the laser light flux enters into the objective lens 15, to when the laser light flux is emitted from the objective lens 15.

Also, the change amounts Δ3 of Examples (17)-(22) were calculated by simulation to obtain the results shown in FIG. 21(c), FIG. 22(c), through FIG. 26(c). In these Examples, the change amount Δ3 and the change amount Δ5 had the same values, where, the change amounts Δ3 is a change amount in a phase difference between a phase Pp3 of P-polarized light and a phase Ps3 of S-polarized light of the laser light flux with a wavelength of λ3, from when the laser light flux enters into the antireflection film 151, to when the laser light flux is emitted from the antireflection film 151. The change amounts Δ6 is a change amount in a phase difference between a phase Pp3 of a P-polarized light and a phase Ps3 of a S-polarized light of the laser light flux with a wavelength of λ3, from when the laser light flux enters into the objective lens 15, to when the laser light flux is emitted from the objective lens 15.

It was seen that, in all of the objective lens 15, when the maximum angle θ1 formed by the normal of the optical functional surface 152 formed on the antireflection film 151 and the laser light flux with the wavelength λ1 is 40°≦θ1≦70°, the change amount Δ1 in phase difference is |Δ1|≦6° and change amount Δ4 in phase difference is |Δ4|≦6°.

Also, it was seen that, in all of the objective lens 15, when the maximum angle θ2 formed by the normal of the optical functional surface 152 formed on the antireflection film 151 and the laser light flux with the wavelength λ2 is 40°≦θ2≦60°, the change amount Δ2 in phase difference is |Δ2|≦6° and change amount Δ5 in phase difference is |Δ5|≦6°.

Also, it was seen that, in all of the objective lens 15, when the maximum angle θ3 formed by the normal of the optical functional surface 152 formed on the antireflection film 151 and the laser light flux with the wavelength λ3 is 40°≦θ3≦50°, the change amount Δ3 in phase difference is |Δ3|≦6° and change amount Δ6 in phase difference is |Δ6|≦6°.

### Comparative Example

### <Structure of Objective Lens>

The objective lens having the structure shown in the following Table 23 is formed as the Comparative Example of the objective lens 15 in the above embodiment.

The objective lens 15 in the examples converges laser light with a wavelength of λ1 on an information recording medium R such as BD or HD-DVD, converges laser light with the wavelength λ2 on DVD, and converges laser light with the wavelength λ3 on CD. The configuration of the lens body 15 can be a configuration known heretofore.

TABLE 23

| | | Refractive | |
|---|---|---|---|
| Layer | Material | Index | Thickness |
| Air | | 1 | |
| 7 | L5-A | 1.47 | 101.00 |
| 6 | ZrO₂-A | 1.90 | 64.00 |
| 5 | L5-A | 1.47 | 16.00 |
| 4 | ZrO₂-A | 1.90 | 59.28 |
| 3 | L5-A | 1.47 | 45.00 |
| 2 | ZrO₂-A | 1.90 | 15.99 |
| 1 | L5-A | 1.47 | 80.00 |
| Lens | Polyolefin | 1.55 | |
| | resin | | |

### <Evaluation of Reflectance Properties>

The reflectance properties of the objective lens 15 of the Comparative Example formed as described above was measured, to obtain the results shown in FIG. 27(a). This shows that, in all of the objective lens 15, favorable transmittance was obtained for each light in the wavelength regions of 390 nm to 430 nm, 530 nm to 570 nm and 760 nm to 820 nm.

### <Evaluation of Change Amount in Phase Difference>

The change amounts Δ1 of the Comparative Example were calculated by simulation as was the case in Example 1 to obtain the results shown in FIG. 27(b). In the Comparative Example, the change amount Δ1 and the change amount Δ4 had the same values. Where, the change amounts Δ1 is a change amount in a phase difference between a phase Pp1 of P-polarized light and a phase Ps1 of S-polarized light of the laser light flux with a wavelength of λ1, from when the laser light flux enters into the antireflection film 151, to when the laser light flux is emitted from the antireflection film 151. The change amounts Δ4 is a change amount in a phase difference between a phase Pp1 of a P-polarized light and a phase Ps1 of a S-polarized light of the laser light flux with a wavelength of λ1, from when the laser light flux enters into the objective lens 15, to when the laser light flux is emitted from the objective lens 15.

Similarly, the change amounts Δ2 of the Comparative Example were calculated by simulation to obtain the results shown in FIG. 27(c). In the comparative Example, the change amount Δ2 and the change amount Δ5 had the same values. Where, the change amounts Δ2 is a change amount in a phase difference between a phase Pp2 of P-polarized light and a phase Ps2 of S-polarized light of the laser light flux with a wavelength of λ2, from when the laser light flux enters into the antireflection film 151, to when the laser light flux is emitted from the antireflection film 151. The change amounts Δ5 is a change amount in a phase difference between a phase Pp2 of a P-polarized light and a phase Ps2 of a S-polarized light of the laser light flux with a wavelength of λ2, from when the laser light flux enters into the objective lens 15, to when the laser light flux is emitted from the objective lens 15.

Also, the change amounts λ3 of the Comparative Example were calculated by simulation to obtain the results shown in FIG. 27(d). In the Comparative Examples, the change amount Δ3 and the change amount Δ6 had the same values. Where, the change amounts Δ3 is a change amount in a phase difference between a phase Pp3 of P-polarized light and a phase Ps3 of S-polarized light of the laser light flux with a wavelength of λ3, from when the laser light flux enters into the antireflection film 151, to when the laser light flux is emitted from the antireflection film 151. The change amounts Δ6 is a change amount in a phase difference between a phase Pp3 of a P-polarized light and a phase Ps3 of a S-polarized light of the laser light flux with a wavelength of λ3, from when the laser light flux enters into the objective lens 15, to when the laser light flux is emitted from the objective lens 15.

It was seen that, in the objective lens 15 of the Comparative Example, when the maximum angle θ1 formed by the normal of the optical functional surface formed on the antireflection 151 and laser light flux with a wavelength λ1 is 40°≦θ1≦70°, the change amount λ1 in phase difference is |Δ1|>6° and change amount Δ4 in phase difference is |Δ4|>6°.

In addition, when the maximum angle θ2 formed by the normal of the optical functional surface formed on the antireflection 151 and laser light flux with a wavelength λ2 is 40°≦θ2≦60°, the change amount Δ2 in phase difference is |Δ2|>6° and change amount Δ5 in phase difference is |Δ5|>6°.

Also, when the maximum angle θ3 formed by the normal of the optical functional surface formed on the antireflection 151 and laser light flux with a wavelength λ3 is 40°≦θ3≦50°, the change amount Δ3 in phase difference is |Δ3|>6° and change amount Δ6 in phase difference is |Δ6|>6°.

Among the above Examples and the Comparative Example, the following data in the Comparative Example, Example 17, Example 20 and Example 15 are shown in Table 24: the change amount |Δ4| in the phase difference of the laser light flux with a wavelength of λ1 from the laser light flux enters into the objective lens 15 to when the laser light flux is emitted from the objective lens 15 when the maximum angle θ1 satisfies 40°≦θ1≦70°; the amount of light loss in the entire optical apparatus 1 due to changes in phase difference and; the effects.

The effects were evaluated as three items which are; transmittance of light in each of the wavelength regions of 390 nm to 430 nm, 630 nm to 670 nm and 760 nm to 820 nm; signal intensity on photodetector 17; and cross talk caused by return light from the optical disk. In the evaluation, the mark A indicates extremely good; the mark B indicates good; the mark C indicates the limit for which use in the optical pickup device; and the mark D indicates that it is problematic for use in the optical apparatus.

TABLE 24

| | Change | Light | | | |
|---|---|---|---|---|---|
| | amount in | loss | Effects | | |
| Typical | phase | amount | Lens | Signal | Cross |
| Examples | difference | (%) | transmittance | strength | talk |
| Comparative | >6° | 5.8 | A | D | D |
| Example | | | | | |
| Example 17 | ≦6° | 3 | A | B | B |
| Example 20 | ≦4° | 1.1 | A | A | A |
| Example 15 | ≦2° | 0.3 | A | A | A |

As shown in FIG. 24, in the objective lens 15 of the Comparative Example, when the maximum angle θ1 formed by the normal of the optical functional surface 152 formed on the antireflection film 151 and the laser light flux having the wavelength λ1 is within the range 40°≦θ1≦70°, the change amount Δ4 of phase difference sometimes exceed 6°, and the amount of resulting light loss in the entire optical pickup apparatus 1 became 5.8%. It was seen that this case, the transmittance for light in the wavelength regions of 330 nm to 430 nm, 630 nm to 670 nm and 760 nm to 820 nm in the objective lens 15 was extremely good, but the signal strength on the photodetector 17 and the cross talk were problematic for use.

In the objective lens 15 of Example 17, when the maximum angle θ1 formed by the normal of the optical functional surface 152 formed on the antireflection film 151 and the laser light flux with the wavelength λ1 is within the range 40°≦θ1≦70°, the change amount |Δ4| in phase difference becomes 6° or less, and the amount of resulting light loss in the entire optical pickup apparatus 1 becomes 3%. It was seen that this case, the transmittance for light in the wavelength regions of 390 nm to 430 nm, 630 nm to 670 nm and 760 nm to 320 nm in the objective lens 15 was extremely good, and the signal strength on the photodetector 17 and the cross talk were good.

In the objective lens 15 of Example 20, when the maximum angle θ1 formed by the normal of the optical functional surface 152 formed on the antireflection film 151 and the laser light flux with the wavelength λ1 is within the range 40°≦θ1≦70°, the change amount |Δ4| of phase difference becomes 4° or less, and the amount of resulting light loss in the entire optical pickup apparatus 1 became 1.1%. It was seen that this case, the transmittance of light in the wavelength regions of 390 nm to 430 nm, 630 nm to 670 nm and 760 nm to 820 nm in the objective lens 15, the signal strength on the photodetector 17 and the cross talk were extremely good.

In the objective lens 15 of Example 15, when the maximum angle θ1 formed by the normal of the optical functional surface 152 formed no the antireflection film 151 and the laser light flux with the wavelength λ1 is within the range 40°≦θ1≦70°, the change amount |Δ4| in phase difference becomes 2° or less, and the amount of resulting light loss in the entire optical pickup apparatus 1 becomes 0.3%. It was seen that this case, the transmittance for light in the wavelength regions of 390 nm to 430 nm, 630 nm to 670 nm and 760 nm to 820 nm in the objective lens 15, the signal strength on the photodetector 17 and the cross talk were extremely good.

As shown above, in the optical element and optical pickup apparatus relating to the present invention, high transmittance can be maintained while keeping a favorable beam spot shape, and cross talk which is caused by return light from the optical disk can be reduced or prevented and also slight weakening of the signals can be reduced or prevented.

Although the present invention has been fully described by way of example with reference to the accompanying drawings, it is to be understood that various changes and modifications will be apparent to those skilled in the art. Therefore, unless otherwise such changes and modifications depart from the scope of the present invention hereinafter defined, they should be construed as being included therein.

What is claimed is:

1. An optical element for use in an optical pickup apparatus which records and/or reproduces information and for converging a first laser light flux with a wavelength λ1 on an information recording medium, the optical element comprises:
a main body; and
an antireflection film arranged on at least one surface of the main body and comprising an optical functional surface,
wherein a maximum angle θ1 formed by a normal of the optical functional surface and the first laser light flux satisfies 40°≦θ1≦70°, and
the optical element satisfies |Δ4|≦6°,
where Δ4 is a change amount in a phase difference between a phase Pp1 of a P-polarized light and a phase Ps1 of a S-polarized light of the first laser light flux, from when the first laser light flux enters into the optical element, to when the first laser light flux is emitted from the optical element.

2. The optical element of claim 1,
wherein the antireflection film satisfies |Δ1|≦6°,
where Δ1 is a change amount in the phase difference between a phase Pp1 of a P-polarized light and a phase Ps1 of a S-polarized light of the first laser light flux, from when the first laser light flux enters into the antireflection film, to when the first laser light flux is emitted from the antireflection film.

3. The optical element of claim 1,
wherein the wavelength λ1 satisfies 390 nm≦λ1≦430 nm.

4. The optical element of claim 1,
wherein the optical element further converges a second laser light flux with a wavelength λ2 (630 nm≦λ2≦670 nm) and a third laser light flux with a wavelength λ3 (760 nm≦λ3≦820 nm) on respective information recoding media, and
the wavelength λ1 satisfies 390 nm≦λ1≦430 nm.

5. The optical element of claim 4,
wherein a maximum angle θ2 formed by a normal of the optical functional surface and the second laser light flux satisfies 40°≦θ2≦60°, and
the optical element satisfies |Δ5|≦6°,
where Δ5 is a change amount in a phase difference between a phase Pp2 of a P-polarized light and a phase Ps2 of a S-polarized light of the second laser light flux, from when the second laser light flux enters into the optical element, to when the second laser light flux is emitted from the optical element, and
wherein a maximum angle θ3 formed by a normal of the optical functional surface and the third laser light flux satisfies 40°≦θ3≦50°, and
the optical element satisfies |Δ6|≦6°,
where Δ6 is a change amount in a phase difference between a phase Pp3 of a P-polarized light and a phase Ps3 of a S-polarized light of the third laser light flux, from when the third laser light flux enters into the optical element, and to when the third laser light flux is emitted from the optical element.

6. The optical element of claim 4,
wherein a maximum angle θ2 formed by a normal of the optical functional surface and the second laser light flux satisfies 40°≦θ2≦60°, and
the antireflection film satisfies |Δ2|≦6°,
where Δ2 is a change amount in the phase difference between a phase Pp2 of a P-polarized light and a phase Ps2 of a S-polarized light of the second laser light flux from when the second laser light flux enters into the antireflection film, to when the second laser light flux is emitted from the antireflection film, and
wherein a maximum angle θ3 formed by a normal of the optical functional surface and the third laser light flux satisfies 40°≦θ3≦50°, and
the optical antireflection film |Δ3|≦6°,
where λ3 is a change amount in the phase difference between a phase Pp3 of a P-polarized light and a phase Ps3 of a S-polarized light of the third laser light flux, from when the third laser light flux enters into the antireflection film, to when the third laser light flux is emitted from the antireflection film.

7. The optical element of claim 1,
wherein the change amount Δ4 satisfies |Δ4|≦4°.

8. The optical element of claim 1,
wherein the change amount Δ4 satisfies |Δ4|≦1°.

9. The optical element of claim 2,
wherein the change amount Δ1 satisfies |Δ1|≦4°.

10. The optical element of claim 9,
wherein the change amount Δ1 satisfies |Δ1|≦1°.

11. The optical element of claim 1,
wherein each of opposite surfaces of the optical element comprises the antireflection film.

12. The optical element of claim 1,
wherein the antireflection film comprises:
a lower refractive index material satisfying 1.3≦n<1.55; and
a higher refractive index material satisfying 1.8≦n<2.5,
where n is a refractive index of each of the lower refractive index material and the higher refractive index material for a light flux with a wavelength of 500 nm.

13. The optical element of claim 12,
wherein the antireflection film is formed of a plurality of layers whose numbers are from 5 to 11, and
the antireflection film satisfies 0.4≦δ≦0.55,
where δ is a refractive-index difference of neighboring layers among the plurality of layers.

14. The optical element of claim 12,
wherein the lower refractive index material comprises MgF₂ or SiO₂ as a main component, and
the higher refractive index material comprises TiO₂, Ta₂O₅, CeO₂, ZrO₂, HfO₂, La₂O₃, Nb₂O₅, or TiLaOx as a main component.

15. The optical element of claim 14,
wherein the lower refractive index material comprises MgF₂ or SiO₂ as a main component, and
the higher refractive index material comprises TiO₂, Ta₂O₅, CeO₂, ZrO₂, or HfO₂ as a main component.

16. The optical element of claim 14,
wherein the lower refractive index material comprises SiO₂ as a main component, and
the higher refractive index material comprises ZrO₂ or HfO₂ as a main component.

17. The optical element of claim 1,
wherein the antireflection film comprises:
a lower refractive index material satisfying 1.3≦n≦1.55;
a middle refractive index material satisfying 1.55≦n<1.8; and
a higher refractive index material satisfying 1.8≦n<2.5,
where n is a refractive index of the lower refractive index material, the middle refractive index material, and the higher refractive index material for a light flux with a wavelength of 500 nm.

18. The optical element of claim 17,
wherein the lower refractive index material comprises MgF₂ or SiO₂ as a main component,
the middle refractive index material comprises Al₂O₃ as a main component, and
the higher refractive index material comprises TiO₂, Ta₂O₅, CeO₂, ZrO₂, HfO₂, La₂O₃, Nb₂O₅, or TiLaOx as a main component,

19. The optical element of claim 18,
wherein the lower refractive index material comprises MgF₂ or SiO₂ as a main component,
the middle refractive index material comprises Al₂O₃ as a main component, and
the higher refractive index material comprises TiO₂, Ta₂O₅, CeO₂, ZrO₂, or HfO₂ as a main component.

20. The optical element of claim 1,
the optical element is formed by a plastic molding.

21. An optical pickup apparatus comprising:
a laser light source for emitting a laser light flux with a wavelength λ1; and
the optical element of claim 1,
wherein the optical element converges the laser light flux on an information recording medium so that the maximum angle θ1 satisfies 40°θ1≦70°, and
the optical pickup apparatus conducts at least one of: recording information to the information recording medium; and reproducing information recorded on the information recording medium.
